(19) United States
(12) Patent Application Publication
(10) Pub. No.: US 2026/0083607 A1
(43) Pub. Date: Mar. 26, 2026

(54) UPPER BODY DECK SECTION FOR A PATIENT SUPPORT APPARATUS

(71) Applicant: UMANO MEDICAL INC., L'Islet (CA)

(72) Inventors: Sylvain BEAULIEU, Levis (CA); William TREMBLAY, Quebec (CA); Jimmy LAFLAMME LAROCHE, Levis (CA)

(73) Assignee: UMANO MEDICAL INC., L'Islet (CA)

(21) Appl. No.: 19/309,754

(22) Filed: Aug. 26, 2025

Related U.S. Application Data
(60) Provisional application No. 63/697,081, filed on Sep. 20, 2024.

(51) Int. Cl. A61G 7/015; A61G 7/10

(52) U.S. Cl. CPC A61G 7/015; A61G 7/1086

(57) ABSTRACT

An upper body deck section has a supporting structure, and an articulation mechanism operatively connected to the supporting structure and to a frame of a patient support apparatus. The articulation mechanism includes a linkage assembly guiding movement of the supporting structure between a lowered position and a raised position. In the lowered position, the deck section panel extends at a first angle and a foot end of a deck section panel of the supporting structure is disposed at a first height. In the raised position, the deck section panel is disposed at a second greater angle and the foot end is disposed at a second greater height. The foot end is positioned further headward in the raised position than in the lowered position. As the supporting structure is moved from the lowered position to the raised position, the foot end does not move vertically lower than the first height.

### CROSS-REFERENCE

The present application claims priority from U.S. Provisional Patent Application No. 63/697,081, filed September 20, 2024, the entirety of which is incorporated by reference herein.

### FIELD OF TECHNOLOGY

The present technology relates to patient support apparatuses, and in particular to articulation mechanisms for the upper body deck sections thereof.

### BACKGROUND

Hospital beds and other types of patient support apparatuses are built with many features that help control a position of a patient. One such feature is the control of an angle of an upper body deck section (sometimes referred to as a “backrest” or “fowler”) of the bed. Notably, the inclination of the upper body deck section is often changed during use as it determines whether the patient is lying down flat, lying at an angle, or even sitting.

However, in many conventional hospital beds, the patient can be subjected to discomfort as the angle of the upper body deck section is adjusted, particularly as it is raised. For instance, in some cases, patients can feel as though they are being compressed when the upper body deck section is raised. Also, in some cases, the movement of the upper body deck section may cause patients to undesirably migrate along the bed (e.g., slipping towards the foot of the bed), sometimes requiring caregivers to manually reposition patients which can be physically exerting and potentially hazardous for caregivers. Many different solutions have been proposed to provide a more optimal movement to the upper body deck section that is more comfortable for the patient. Nonetheless, these solutions can be complex and costly to implement, for example requiring multiple independent mechanisms to achieve the desired motion, or do not sufficiently address the problem.

In view of the foregoing, there is a need for an upper body deck section that addresses at least some of these drawbacks.

### SUMMARY

It is an object of the present technology to ameliorate at least some of the inconveniences present in the prior art.

According to an aspect of the present technology, there is provided an upper body deck section for a patient support apparatus, comprising: a supporting structure including a deck section panel for supporting a support surface thereon, the deck section panel having a head end and a foot end opposite the head end; and an articulation mechanism operatively connected to the supporting structure and configured to be connected to a frame of the patient support apparatus, the articulation mechanism including at least one linkage assembly including a plurality of links pivotably connected to each other and collaborating to guide movement of the supporting structure between a lowered position and a raised position, at least a majority of a range of motion of the supporting structure being spanned between the lowered position and the raised position, in the lowered position, the deck section panel extending at a first angle relative to a horizontal plane and the foot end of the deck section panel being disposed at a first height, in the raised position, the deck section panel being disposed at a second angle relative to the horizontal plane and the foot end of the deck section panel being disposed at a second height, the second angle being greater than the first angle, the second height being greater than the first height, the foot end of the deck section panel being positioned further headward in the raised position than in the lowered position, the at least one linkage assembly being configured such that, as the supporting structure is moved from the lowered position to the raised position, the foot end of the deck section panel does not move vertically lower than the first height.

In some embodiments, the at least one linkage assembly is configured to guide the supporting structure such that the deck section panel remains generally tangential to an arc as the deck section panel is moved between the lowered and raised positions.

In some embodiments, the arc is a section of a circle or ellipse centered about an axis extending laterally and vertically higher than the first height.

In some embodiments, the first angle is equal to or less than 10°.

In some embodiments, the first angle is approximately 0° such that the deck section panel is generally parallel to the horizontal plane in the lowered position.

In some embodiments, the supporting structure comprises a chassis connected to the deck section panel, the chassis including left and right longitudinal members extending generally parallel to each other, the at least one linkage assembly being operatively connected to the chassis.

In some embodiments, the deck section panel is longitudinally fixed relative to the left and right longitudinal members.

In some embodiments, each of the at least one linkage assembly is a six-bar linkage.

In some embodiments, the plurality of links comprises: a first link configured to be pivotably connected to the frame of the patient support apparatus at a first joint; a second link configured to be pivotably connected to the frame of the patient support apparatus at a second joint; a third link pivotably connected to the first link and to the supporting structure; and a fourth link pivotably connected to the second link and to the supporting structure, throughout movement of the supporting structure between the lowered and raised positions, the first joint and the second joint are disposed on a foot side of a vertical plane bisecting a length of the deck section panel.

In some embodiments, all connections between the at least one linkage assembly and the frame remain on the foot side of the vertical plane throughout movement of the supporting structure between the lowered and raised positions.

In some embodiments, the third link is pivotably connected to the first link at a third joint; the fourth link is pivotably connected to the second link at a fourth joint; in the lowered position, a longitudinal distance between the third joint and the foot end of the deck section panel is less than a longitudinal distance between the fourth joint and the foot end of the deck section panel; and in the raised position, the longitudinal distance between the third joint and the foot end of the deck section panel is greater than the longitudinal distance between the fourth joint and the foot end of the deck section panel.

In some embodiments, in a side elevation view of the at least one linkage assembly, the third link extends through the second link irrespective of a position of the supporting structure.

In some embodiments, the third link is pivotably connected to the second link.

In some embodiments, the at least one linkage assembly includes a four-bar linkage.

In some embodiments, the at least one linkage assembly further comprises a damper for damping a motion of the supporting structure towards the lowered position.

In some embodiments, the upper body deck section further comprises at least one biasing assembly configured to bias the supporting structure away from the lowered position when the supporting structure is in the lowered position.

In some embodiments, the biasing assembly comprises: a sleeve; a piston received within the sleeve and movable axially along the sleeve; and a biasing element forcing the piston outward from the sleeve so that the piston abuts a part of the at least one linkage assembly in the lowered position of the supporting structure to bias the supporting structure toward the raised position.

In some embodiments, the at least one linkage assembly includes a left linkage assembly and a right linkage assembly that are laterally spaced from each other.

In some embodiments, the upper body deck section further comprises an actuator mount configured for mounting a linear actuator thereto in order to actuate the at least one linkage assembly, the linear actuator being mountable between the actuator mount and the frame of the patient support apparatus.

In some embodiments, the raised position corresponds to a fully raised position of the supporting structure.

In some embodiments, in the raised position, the deck section panel is at an angle of at least 60° relative to the horizontal plane.

In some embodiments, the upper body deck section further comprises at least one retainer for limiting movement of the support surface supported by the upper body deck section, the at least one retainer being connected to the supporting structure and projecting upwardly from the deck section panel generally perpendicularly thereto, the at least one retainer being configured to be inserted into a slot of the support surface in order to retain the support surface relative to the deck section panel as the supporting structure moves between the lowered and raised positions.

In some embodiments, a patient support apparatus comprises: a base; a frame movable relative to the base; an elevation system operatively connecting the frame to the base to move the frame relative to the base; a deck configured to support a support surface thereon, the deck being connected to the frame, the deck including a plurality of deck sections including the upper body deck section.

In some embodiments, the deck further comprises: a seat deck section adjacent to the upper body deck section, the seat deck section having a seat deck section panel for supporting the support surface; and a gap filling panel fixed to the seat deck section and engaged with the supporting structure of the upper body deck section, the gap filling panel extending between the seat deck section and the upper body deck section to fill a gap between the upper body deck section panel and the seat deck section panel, the gap filling panel elastically deforming in response to the supporting structure being moved to the raised position, the gap filling panel being retained between the deck section panel and a chassis of the upper body deck section.

In some embodiments, the patient support apparatus further comprises at least one retainer for limiting movement of the support surface supported by the upper body deck section, the at least one retainer being connected to the supporting structure and projecting upwardly from the deck section panel generally perpendicularly thereto, the at least one retainer being configured to be inserted into a slot of the support surface in order to retain the support surface relative to the deck section panel as the supporting structure moves between the lowered and raised positions, the at least one retainer collaborating with the gap filling panel to help the support surface follow the movement of the upper body deck section.

According to another aspect of the present technology, there is provided an upper body deck section for a patient support apparatus, comprising: a supporting structure including a deck section panel for supporting a support surface thereon, the deck section panel having a head end and a foot end opposite the head end; and an articulation mechanism operatively connected to the supporting structure and configured to be connected to a frame of the patient support apparatus, the articulation mechanism including at least one linkage assembly including a plurality of links pivotably connected to each other and collaborating to guide movement of the supporting structure between a lowered position and a raised position, at least a majority of a range of motion of the supporting structure being spanned between the lowered position and the raised position, the at least one linkage assembly being configured such that the deck section panel remains generally tangential to an arc as the deck section panel is moved between the lowered and raised positions.

In some embodiments, the arc is a section of a circle or ellipse centered about an axis extending laterally and above a height of the deck section panel in the lowered position.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view, taken from a top, front, left side, of a hospital bed according to an embodiment of the present technology;

FIG. 2 is a perspective view, taken from a top, front, right side, of a patient support assembly of the bed of FIG. 1, showing an upper body deck section thereof in a lowered position;

FIG. 3 is a side elevation view of the patient support assembly of FIG. 2;

FIG. 4 is a bottom plan view of the patient support assembly of FIG. 2;

FIG. 5 is a cross-sectional view of the patient support assembly of FIG. 2 taken along line 5-5 of FIG. 4;

FIG. 6 is a perspective view, taken from a top, front, right side, of a hinge of the upper body deck section of FIG. 2;

FIG. 7 is a perspective view, taken from a top, front, right side, of the patient support assembly of FIG. 2, showing the upper body deck section in an intermediate position;

FIG. 8 is a perspective view, taken from a top, front, right side, of the patient support assembly of FIG. 2, showing the upper body deck section in a raised position;

FIG. 9 is a right side elevation view of the patient support assembly of FIG. 8;

FIG. 10 is a perspective view, taken from a top, front, right side, of the upper body deck section in a raised position;

FIG. 11 is a perspective view, taken from a top, rear, right side, of the upper body deck section of FIG. 10;

FIG. 12 is a rear elevation view of the upper body deck section of FIG. 10;

FIG. 13 is a right side elevation view of the upper body deck section of FIG. 10;

FIG. 14 is an exploded view of a linkage assembly of the upper body deck section of FIG. 10, shown in a raised position;

FIG. 15 is a right side elevation view of the linkage assembly of the upper body deck section, shown with an outer side member of a top crank link of the upper body deck section removed to expose a damper;

FIG. 16 is a cross-sectional view of part of the linkage assembly in the lowered position and taken along a vertical plane extending through a biasing assembly;

FIG. 17 is a schematic representation of the upper body deck section of FIG. 10 in the lowered position;

FIG. 18 is a schematic representation of the upper body deck section of FIG. 10 in the intermediate position;

FIG. 19 is a schematic representation of the upper body deck section of FIG. 10 in a raised position;

FIG. 20 is a perspective view, taken from a top, rear, right side, of the upper body deck section in accordance with an alternative embodiment in which the linkage assemblies are configured differently, showing the upper body deck section in a raised position;

FIG. 21 is a cross-sectional view of the upper body deck section of FIG. 20 taken along line 21-21 in FIG. 20;

FIG. 22 is a cross-sectional view of the upper body deck section of FIG. 20 taken along a same plane as FIG. 21, and showing the upper body deck section in the lowered position;

FIG. 23 is a schematic representation of the upper body deck section of FIG. 20 in the lowered position;

FIG. 24 is a schematic representation of the upper body deck section of FIG. 20 in a raised position;

FIG. 25 is a perspective view, taken from a top, front, right side, of part of the upper body deck section of FIG. 10, showing a mattress retainer;

FIG. 26 is a perspective view, taken from a bottom, rear, right side, of the part of the upper body deck section shown in FIG. 25; and

FIG. 27 is a perspective view, taken from a top, rear, right side, of the mattress retainer of FIG. 25 engaged with a mattress.

### DETAILED DESCRIPTION

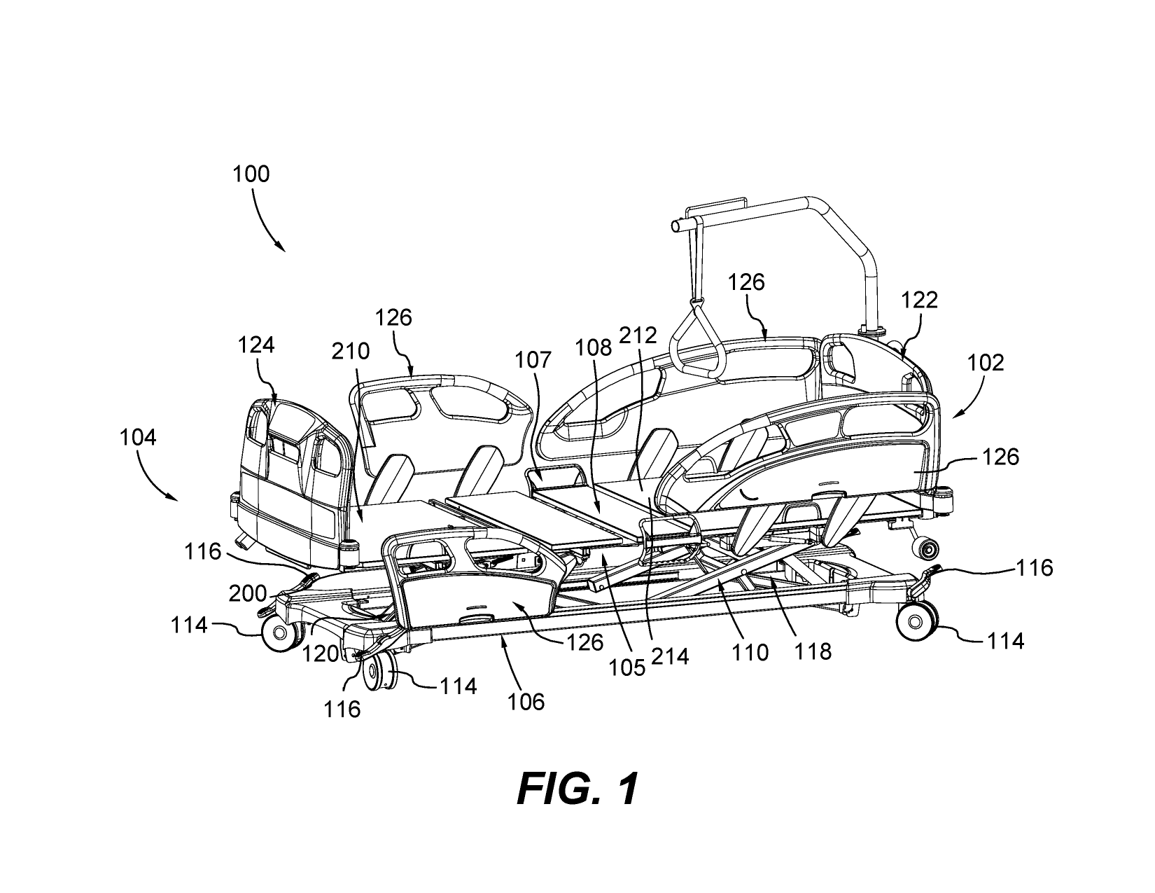

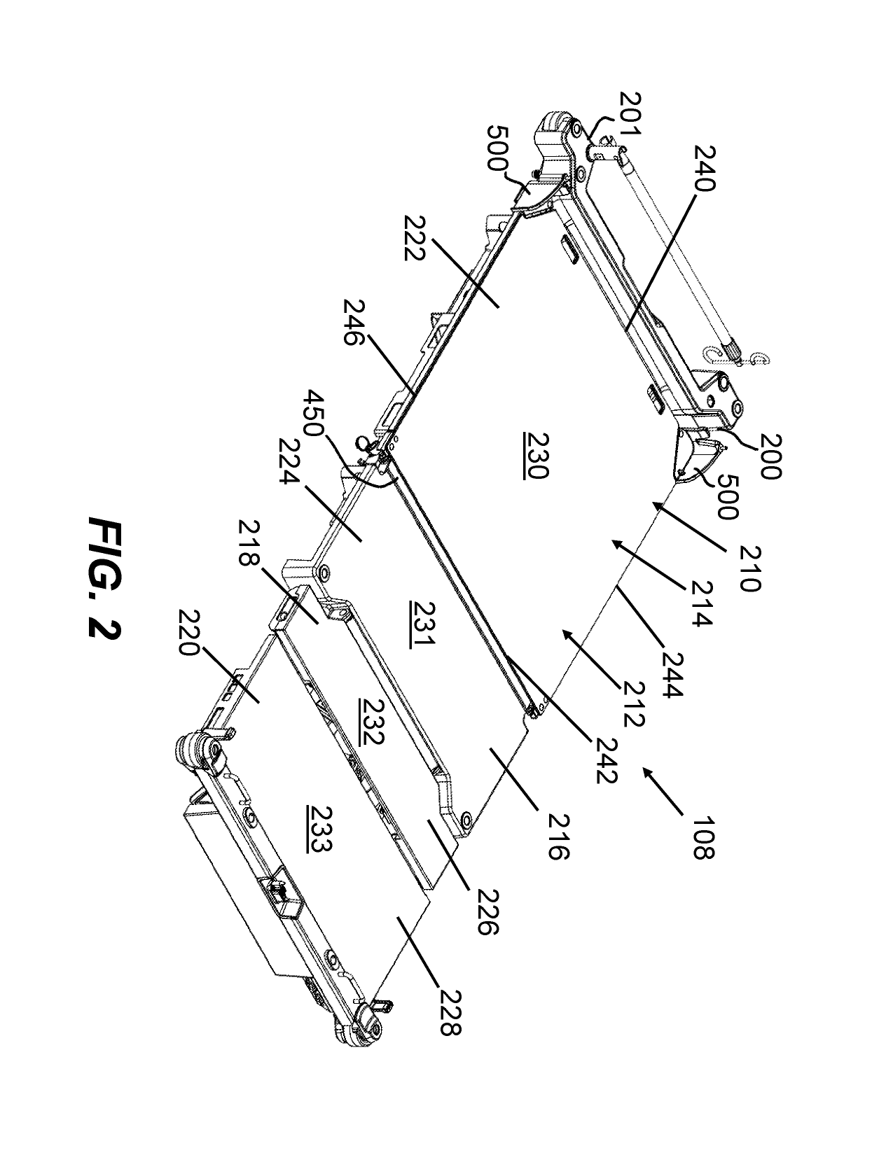

A patient support apparatus 100 in accordance with an embodiment of the present technology is illustrated in FIGS. 1 and 2. The patient support apparatus 100 may be used in a medical setting for supporting a patient. In this embodiment, the patient support apparatus 100 is a hospital bed that is used in a hospital, and in particular in an intensive care unit (ICU) setting. It is contemplated that, in other embodiments, the patient support apparatus 100 may be a different type of patient support apparatus such as, for example, a stretcher, a motorized chair, an operating room table, or other specialty tables (e.g., an examination table).

As will be described in greater detail below, the bed 100 has an upper body deck section 214 that is articulated in such a manner as to optimize comfort for the patient lying on the bed 100 when the position of the upper body deck section 214 is changed.

With reference to FIG. 1, the bed 100 has a head end 102 and a foot end 104 opposite each other and defining a length of the bed 100 therebetween. As will be appreciated, in use, when the patient is lying on the bed 100, the patient’s head is closer to the head end 102 while the patient’s feet are closer to the foot end 104. The bed 100 also has left and right sides 105, 107 extending between the head end 102 and the foot end 104 and defining a width of the bed 100 therebetween.

Some of the structural components of the bed 100 will be designated hereinafter as “right”, “left”, “head” and “foot” from the reference point of an individual lying on their back on the bed 100 with their head oriented toward the head end 102 of the bed 100 and their feet oriented toward the foot end 104 of the bed 100. Similarly, the term “headward” refers to an element located towards the head end 102 of the bed 100 and the term “footward” refers to an element located towards the foot end 104 of the bed 100. Furthermore “interior” and “exterior” views are also designated from the reference point of the patient lying in the bed. Therefore, an interior view shows an element as seen by the patient looking toward the environment outside of the bed and an exterior view shows an element as seen by a person outside of the bed. Generally, an exterior view shows the exterior surfaces of the bed and the interior view shows the interior surfaces of the bed. The terms “inner” and “outer” will similarly be used to describe the position of elements relative to the bed.

The bed 100 has a base 106 and a patient support assembly 108 operatively connected to the base 106. Four casters 114 are connected to the base 106 at respective corners thereof to allow the bed 100 to be moved along a floor. Additional casters may be provided in other embodiments. Respective brakes 116 are provided for each caster 114 to selectively lock and unlock the casters 114. The bed 100 may also have a drive wheel (not shown) connected to the base 106 for driving the bed 100 on the floor.

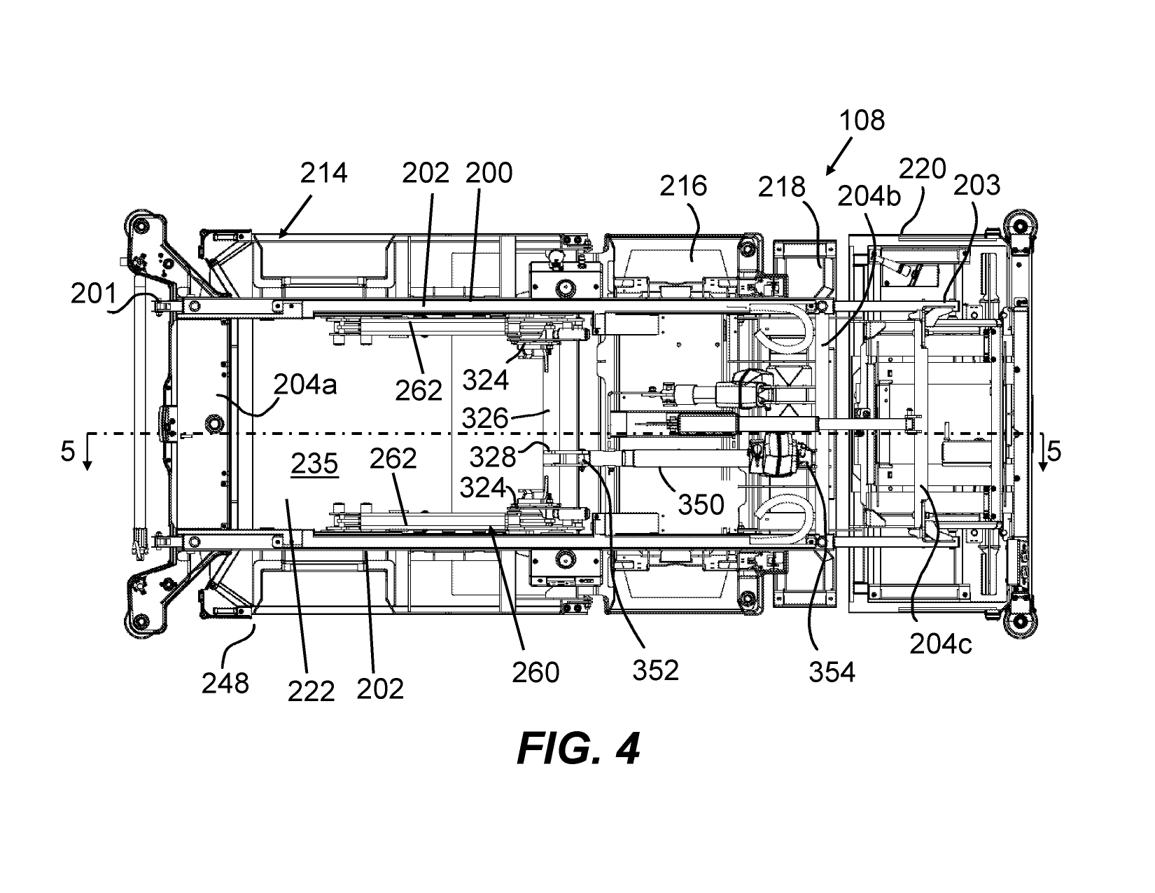

The patient support assembly 108, which is disposed above the base 106, is configured to accommodate the patient thereon and includes an upper frame 200 and a deck 210 supported by the upper frame 200. The upper frame 200 extends from a head end 201 to an opposite foot end 203. As shown in FIG. 4, in this embodiment, the upper frame 200 has left and right longitudinal rails 202 that extend parallel to each other and are interconnected by a plurality of transversal members 204a, 204b, 204c extending therebetween. The upper frame 200 may be configured in any suitable manner in other embodiments.

With reference to FIG. 2, the deck 210 defines a top face 212 on which a support surface such as a mattress or the like is supported. The deck 210 includes a plurality of deck sections that are connected to the upper frame 200 and, in use, support different areas of the patient’s body. Notably, the deck sections forming the deck 210 include an upper body deck section 214 for supporting an upper body of the patient, a seat deck section 216 for supporting the patient’s upper legs area, a thigh deck section 218 for supporting the patient’s thighs, and a foot deck section 220 for supporting the patient’s lower legs and feet. The deck sections 214, 216, 218, 220 are longitudinally consecutive to each other and together form the top face 212. Notably, the upper body deck section 214, seat deck section 216, thigh deck section 218 and foot deck section 220 have an upper body deck section panel 222, a seat deck section panel 224, a thigh deck section panel 226 and a foot deck section panel 228, respectively. The deck section panels 222, 224, 226, 228 define respective top faces 230, 231, 232, 233 such that, together, they form the top face 212 of the deck 210.

The deck sections 214, 216, 218, 220 are movably connected to each other. In particular, the upper body deck section 214 and the thigh deck section 218 are pivotably connected to the seat deck section 216. The foot deck section 220 is pivotably connected to the thigh deck section 218. The seat deck section 216 is fixed to the upper frame 200 but is also movable with a movable portion of the upper frame 200. In this embodiment, the movement of the foot deck section 220 as the bed 100 transitions between different positions is dependent on the movement of the other deck sections, namely of the thigh deck section 218 to which it is connected. That is, in this embodiment, the foot deck section 220 is not directly acted upon by an actuator external to the foot deck section 220 in order to change its position. Instead, the foot deck section 220 follows the motion described by the actuation of the thigh deck section 218. The articulation of the deck sections 216, 218, 220 is described in greater detail in International Application Publication No. WO2024154074, published on July 25, 2024, the entirety of which is incorporated by reference herein.

It is contemplated that fewer deck sections may be provided in other embodiments (e.g., three deck sections).

Referring back to FIG. 1, the bed 100 has a plurality of barriers generally disposed around the patient support assembly 108 including a headboard 122 at the head end 102, a footboard 124 at the foot end 104, and at least one siderail 126 on the left and right sides 105, 107. The siderails 126 can be raised to prevent the patient from falling off the bed 100 or lowered (as shown for one of the siderails 126 in FIG. 1) to allow the patient to exit the bed 100 and/or to allow care providers to access and attend to the patient. In the embodiment shown in FIG. 1, the siderails 126 include two siderails on each side (a head siderail and a foot siderail).

An elevation system 110 operatively connects the patient support assembly 108 to the base 106 to move the patient support assembly 108 relative to the base 106, namely selectively raising or lowering the patient support assembly 108 relative to the base 106. In addition to raising and lowering the patient support assembly 108, the elevation system 110 also allows the bed 100 to assume various different positions such as a flat horizontal position (shown in FIG. 1), a Trendelenburg position, a reverse Trendelenburg position, a cardiac chair position and a full chair position. It is contemplated that, in other embodiments, the bed 100 may be configured to assume more or fewer positions. For instance, in some cases, the bed 100 may permanently remain in the flat horizontal position and simply be raised and lowered by the elevation system 110.

In this embodiment, the elevation system 110 includes a head end lift assembly 118 and a foot end lift assembly 120 which connect the base 106 to a head end portion and a foot end portion of the upper frame 200, respectively. Each of the head end lift assembly 118 and the foot end lift assembly 120 may be raised to a fully extended and lowered to a fully collapsed position. The lift assemblies 118, 120 may be controlled symmetrically so that that the lift assemblies 118, 120 are in equivalent extended positions at the same time (e.g., both in the fully extended position or both in the fully collapsed position), or they may also be controlled asymmetrically so that they are in different extended positions at the same time. For example, in some cases, the head end lift assembly 118 may be in the fully extended position while the foot end lift assembly 120 is in the fully collapsed position or vice-versa (e.g., in the Trendelenburg position).

The bed 100 has many other features that will not be described in detail herein as they are well known in the art. The above description of the bed 100 is thus not meant to be exhaustive but rather to provide sufficient context for the reader.

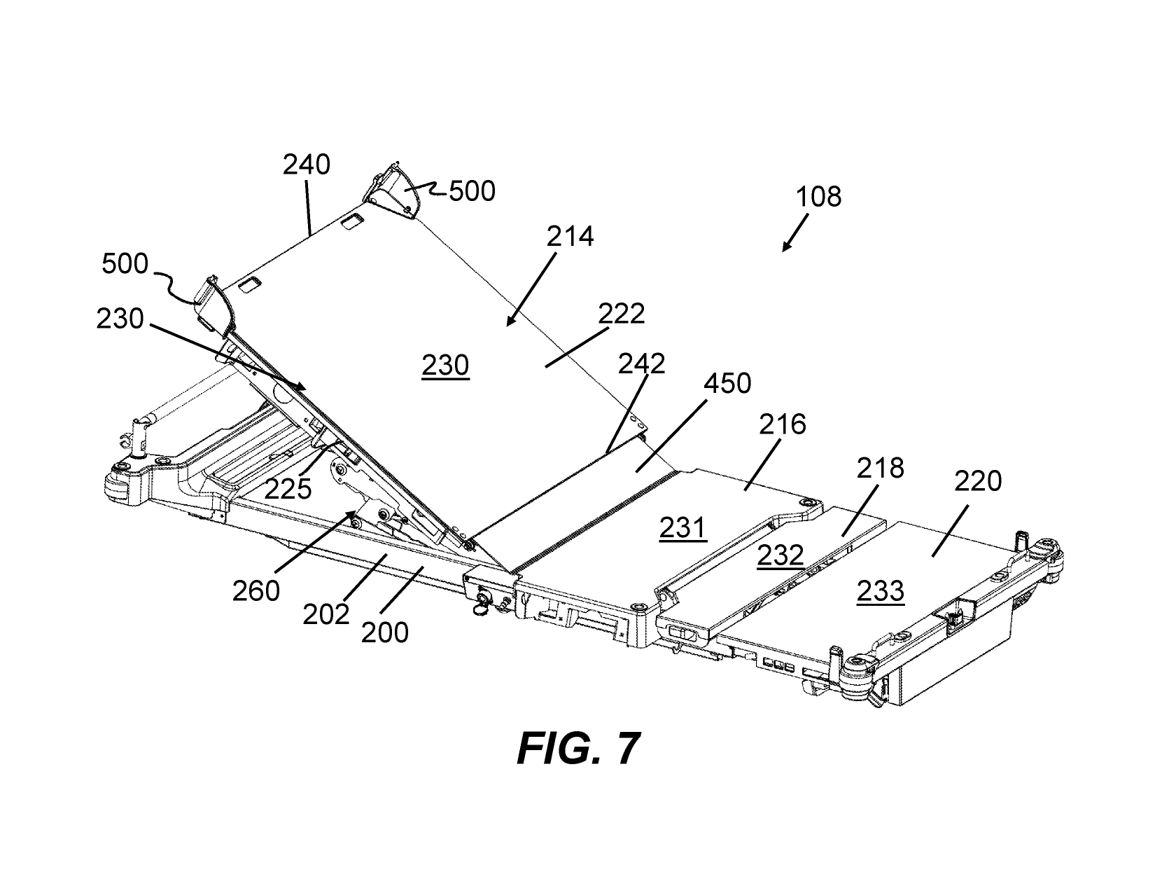

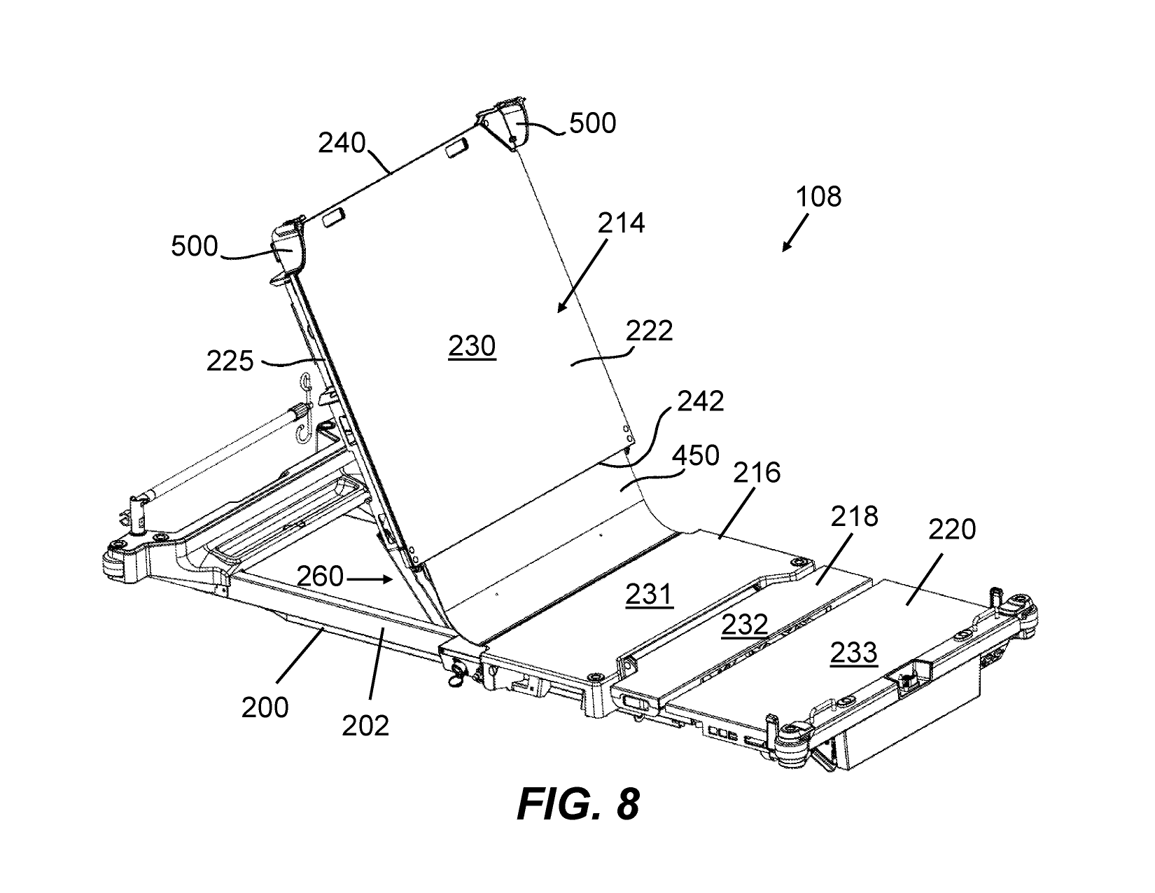

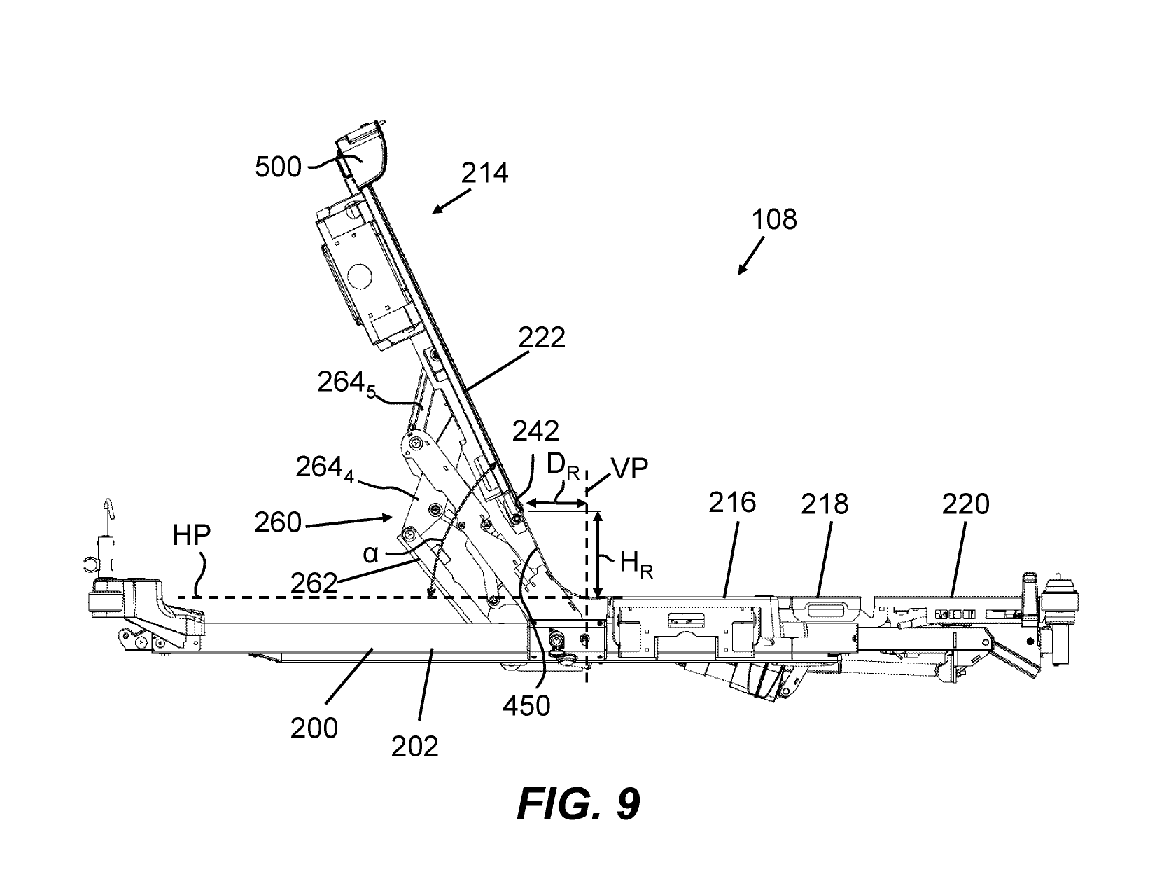

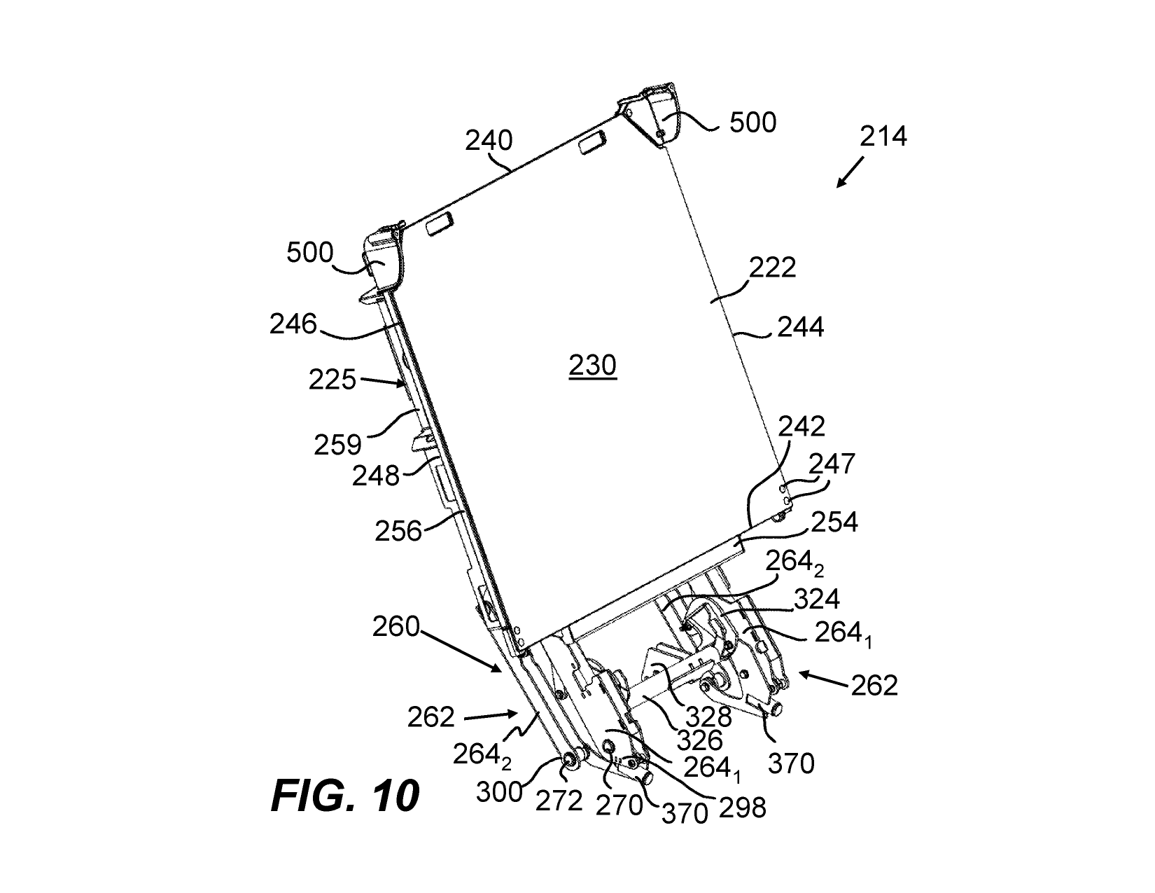

The upper body deck section 214 will now be described in greater detail with reference to FIGS. 10 to 13. The upper body deck section 214 has a supporting structure 225 and an articulation mechanism 260 that operatively connects the supporting structure 225 to the upper frame 200 of the bed 100 to allow motion of the supporting structure 225 relative thereto. More particularly, the articulation mechanism 260 enables the upper body deck section 214, including the supporting structure 225, to move relative to the upper frame 200 between a lowered position (FIGS. 2 to 4) and a raised position (FIGS. 8 and 9), and passing through various intermediate positions therebetween (FIG. 7). In the illustrated embodiment, the lowered position is a horizontally flat position. In the illustrated embodiment, the raised position shown in FIGS. 8 and 9 is considered to be a fully raised position. It will be readily understood that other embodiments could provide a lowered and a fully raised position at a different angle with respect to the horizontal than what is shown in these figures. These positions of the upper body deck section 214 as well as the motion described thereby to attain these positions will be described in more detail below.

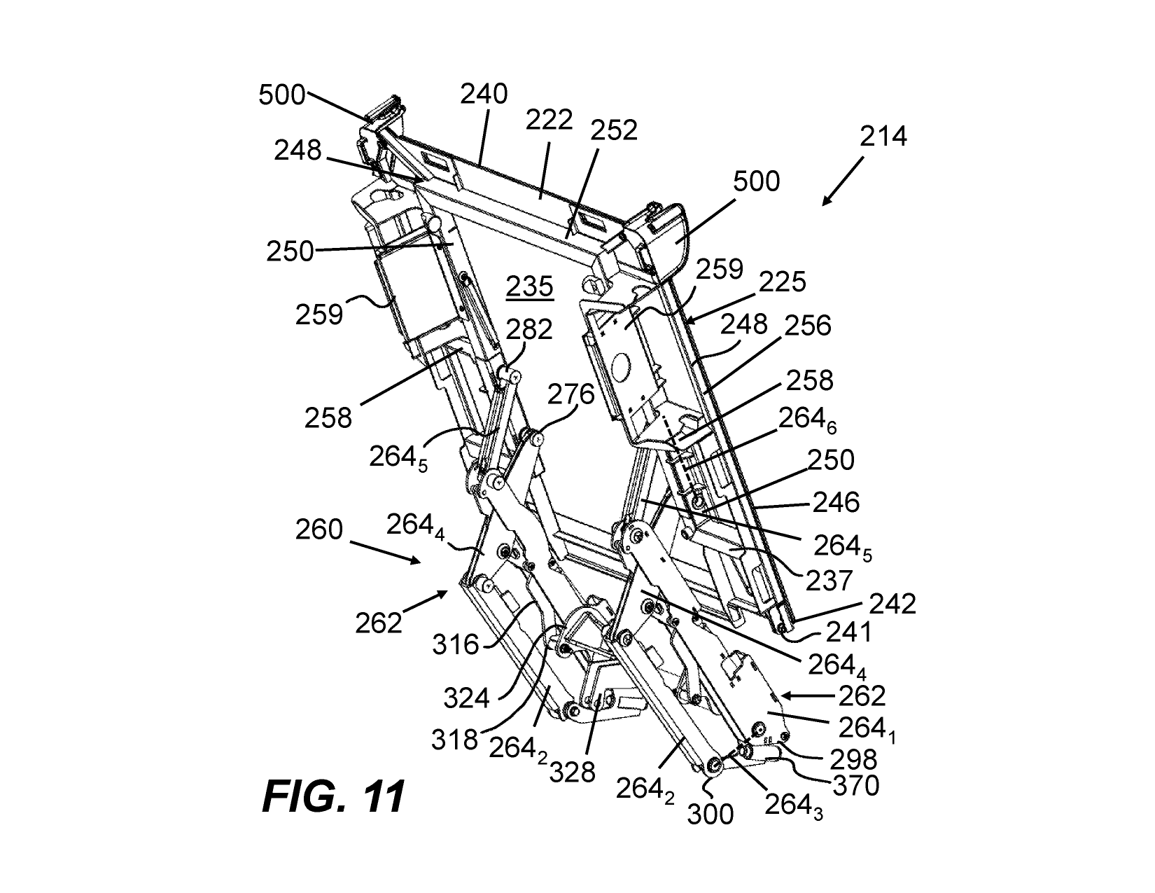

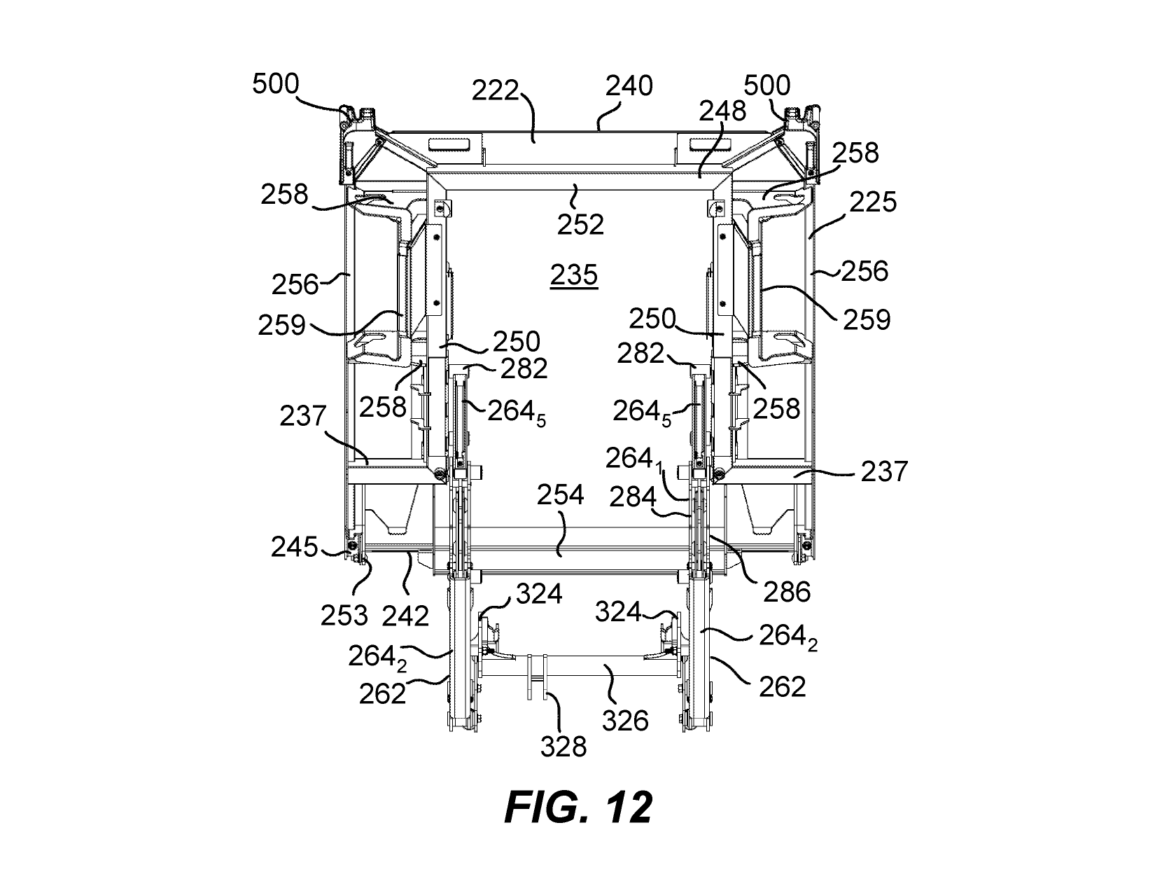

The supporting structure 225 of the upper body deck section 214 includes the deck section panel 222 which defines the top face 230 and an opposite bottom face 235 (FIGS. 11, 12). The top face 230 is generally planar and, in use, faces and supports the mattress. The deck section panel 222 has a head end 240 and an opposite foot end 242, as well as a left end 244 and an opposite right end 246. As best shown in FIGS. 10 to 12, the deck section panel 222 is connected to a chassis 248 of the supporting structure 225. The chassis 248 has left and right longitudinal members 250 extending generally longitudinally, and head end and foot end central lateral braces 252, 254 extending between the longitudinal members 250. Left and right lateral members 237 extend laterally outward from respective ones of the longitudinal members 250. Outer tubes 256 extend parallel to the longitudinal members 250 and are disposed laterally outwardly therefrom. The outer tubes 256 are connected to the longitudinal members 250 by interconnecting flanges 258 extending laterally therebetween and by the lateral members 237. Furthermore, in this embodiment, a siderail mount 259 is provided on each lateral side of the chassis 248, connected to a corresponding longitudinal member 250 thereof, for mounting a respective one of the head siderails 126 of the bed 100 thereto such that the head siderails 126 move together with the upper body deck section 214 during motion of the upper body deck section 214. The chassis 248 may be configured differently in other embodiments.

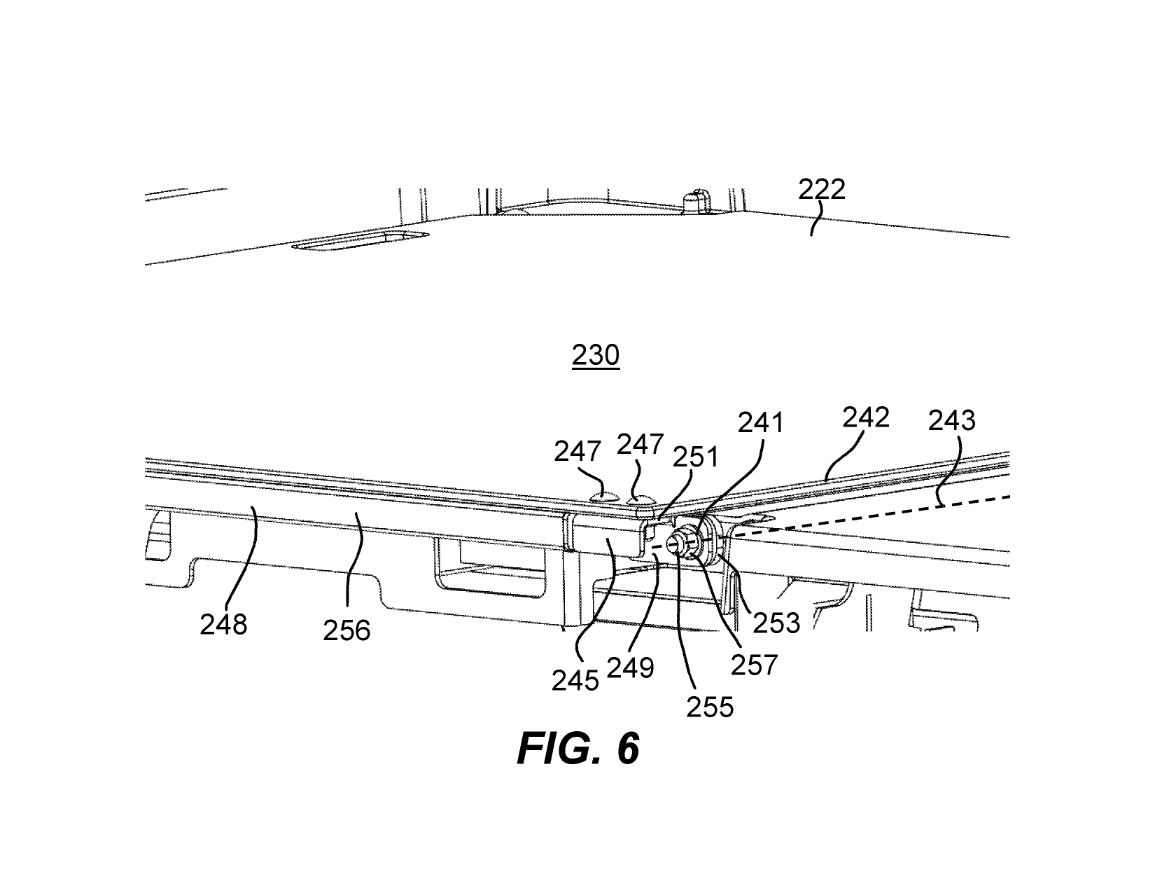

In this embodiment, the deck section panel 222 is pivotably connected to the chassis 248 to allow the deck section panel 222 to be temporarily lifted off the chassis 248. This may be helpful to facilitate cleaning of the upper body deck section 214, namely by allowing easy access to an underside of the deck section panel 222 and the underlying chassis 248, and may also be helpful for maintenance of components of the bed positioned under the upper body deck section 214. In particular, with reference to FIG. 6, the deck section panel 222 is pivotably connected to the chassis 248 at left and right side hinges 241 (the right side hinge 241 being shown in FIG. 6) defining a hinge axis 243 extending laterally. More specifically, the deck section panel 222 is fastened to a hinge connector 245 of each hinge 241 by two fasteners 247 (e.g., bolts). The hinge connector 245 has a vertically-extending portion 249 that extends vertically and a horizontally-extending portion 251 that extends perpendicular from the vertically-extending portion 249. The vertically-extending portion 249 is pivotably connected to a connecting flange 253 that extends from the corresponding lateral member 237 of the chassis 248. Notably, in this example, a fastener 255 along the hinge axis 243 extends through the connecting flange 253, through a bushing (not shown) received by an opening defined by the vertically-extending portion 249, and is secured in place by a nut 257. As a result, the deck section panel 222 is pivotable, together with the hinge connector 245 about the hinge axis 243. In this example, the weight of the deck section panel 222 keeps it in its default position in which the deck section panel 222 rests on the chassis 248 (i.e., with the head end 240 of the deck section panel 222 resting on the head end of the chassis 248). In some cases, a lock system may be provided to ensure that the deck section panel 222 remains resting on the chassis 248.

In this embodiment, the hinges 241 are positioned near the foot end 242 of the deck section panel 222 such that, when the deck section panel 222 is lifted off the chassis 248 via a rotation about the hinges 241, the deck section panel 222 is rotated toward the foot end 104 of the bed 100. As will be explained in more detail below, in some cases, the positioning of the hinges 241 may also be beneficial for retention of a gap filling panel 450 (best shown in FIGS. 6 to 8) by the upper body deck section 214. It is contemplated that, in some embodiments, the hinges 241 may instead be located near the head end 240 of the deck section panel 222.

The hinges 241 may be configured differently in other embodiments. In yet other embodiments, the hinges 241 may be omitted altogether.

As will be appreciated, while the deck section panel 222 can be rotated about the hinge axis 243, the deck section panel 222 cannot be translated longitudinally or laterally relative to the underlying chassis 248. For instance, the deck section panel 222 is longitudinally fixed relative to the longitudinal members 250 of the chassis 248. In other words, the deck section panel 222 is fixed in the direction of the longitudinal members 250. Thus, all other displacements of the deck section panel 222 are ensured by the articulation mechanism 260 rather than independent movements of the deck section panel 222 relative to the chassis 248.

Referring back to FIGS. 10-13, the articulation mechanism 260 of the upper body deck section 214 is operatively connected to the supporting structure 225 and to the upper frame 200. In particular, in this embodiment, the articulation mechanism 260 includes left and right linkage assemblies 262 that are spaced from each other in the lateral direction of the bed 100 and are each interconnected between the upper frame 200 and the supporting structure 225. In this embodiment, the left and right linkage assemblies 262 are mirror images of each other and therefore only the right linkage assembly 262 will be described in detail herein. It is to be understood that the same description applies to the left linkage assembly 262.

The linkage assembly 262 includes a plurality of links that are pivotably connected to each other and collaborate to guide movement of the supporting structure 225 between the lowered and raised positions. In this embodiment, the linkage assembly 262 includes a six-bar linkage that includes six links 264₁-264₆ and seven joints (defining pivot axes extending laterally) governing the movement of the supporting structure 225. The six links of the six-bar linkage include top and bottom crank links 264₁, 264₂, a frame link 264₃, a central link 264₄, an outer link 264₅ and a supporting structure link 264₆.

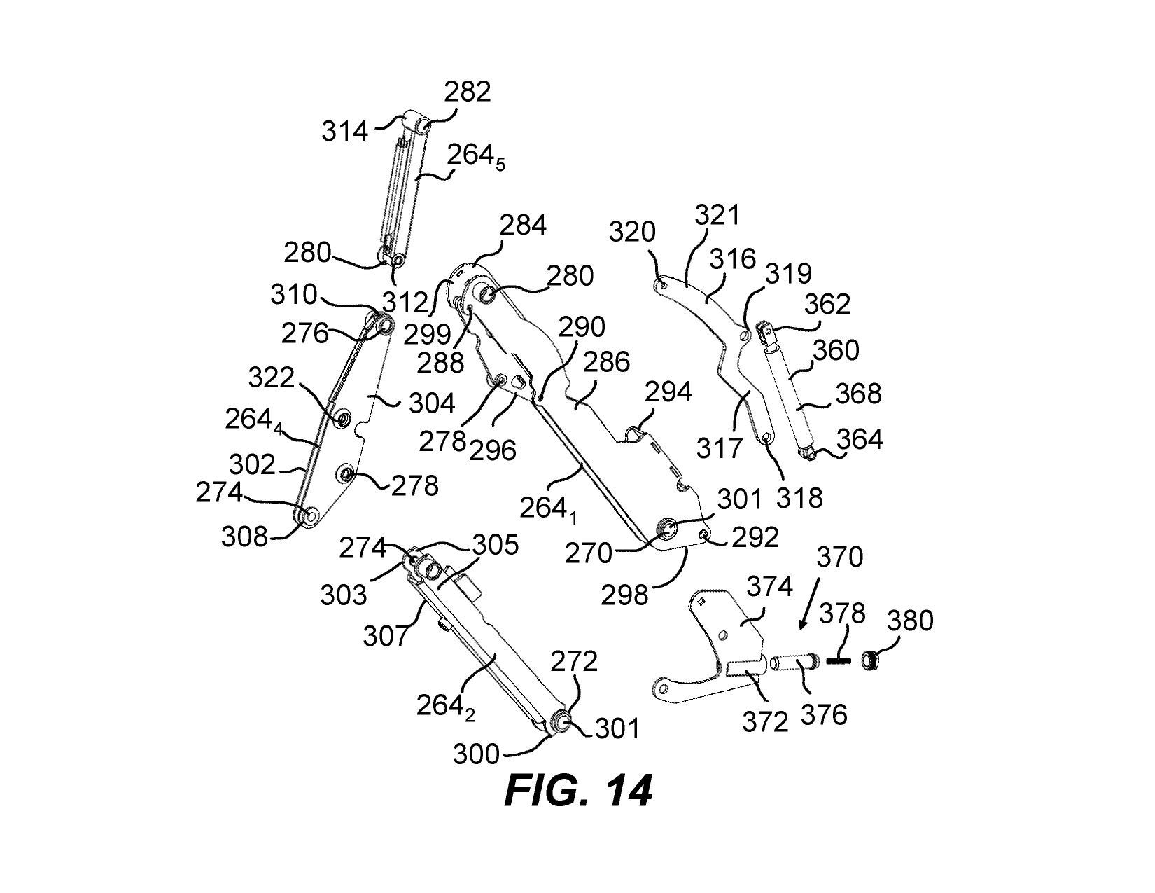

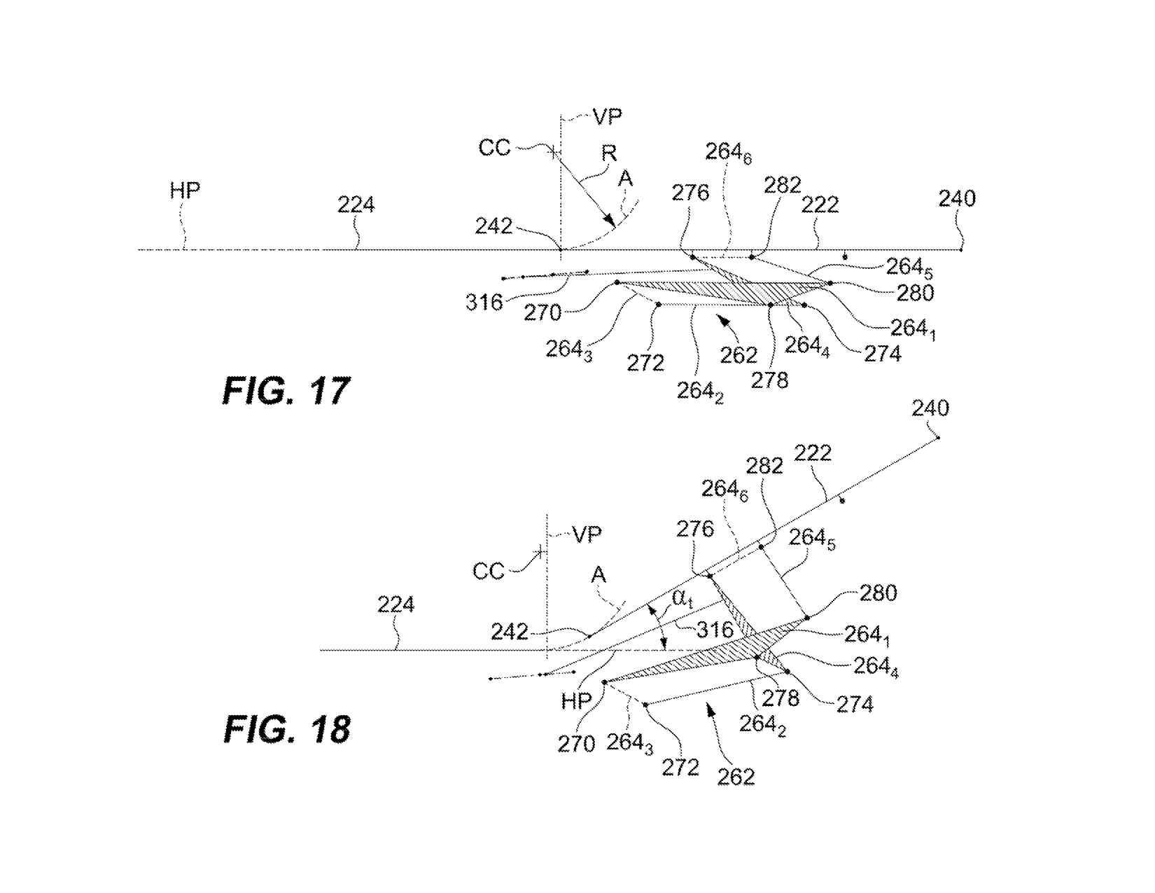

The top and bottom crank links 264₁, 264₂ are pivotably connected to the upper frame 200 at respective joints 270, 272. The joints 270, 272 are thus fixed relative to the upper frame 200. The joint 270 is positioned vertically higher than the joint 272 and footward of the joint 272. As shown in FIGS. 17 to 19, the top and bottom crank links 264₁, 264₂ extend headwardly from the joints 270, 272 irrespective of the position of the upper body deck section 214. The joints 270, 272 are disposed at respective proximal ends 298, 300 of the crank links 264₁, 264₂ and may be configured in any suitable manner. In this example, each joint 270, 272 includes a bushing 301 (FIG. 14) that is fixed to a corresponding longitudinal rail 202 of the upper frame 200, and a sleeve (not shown) receiving the bushing 301 therein. The joints 270, 272 may be configured in any other suitable manner in other embodiments.

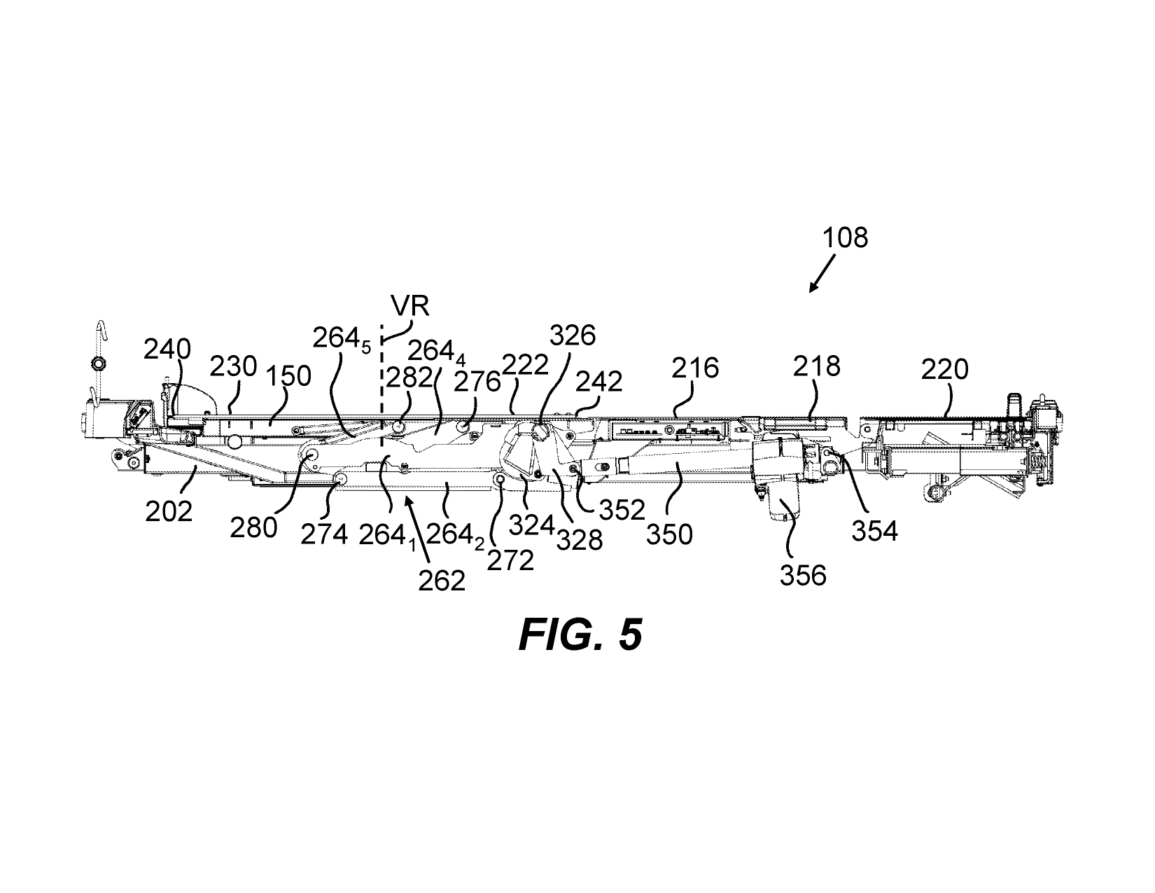

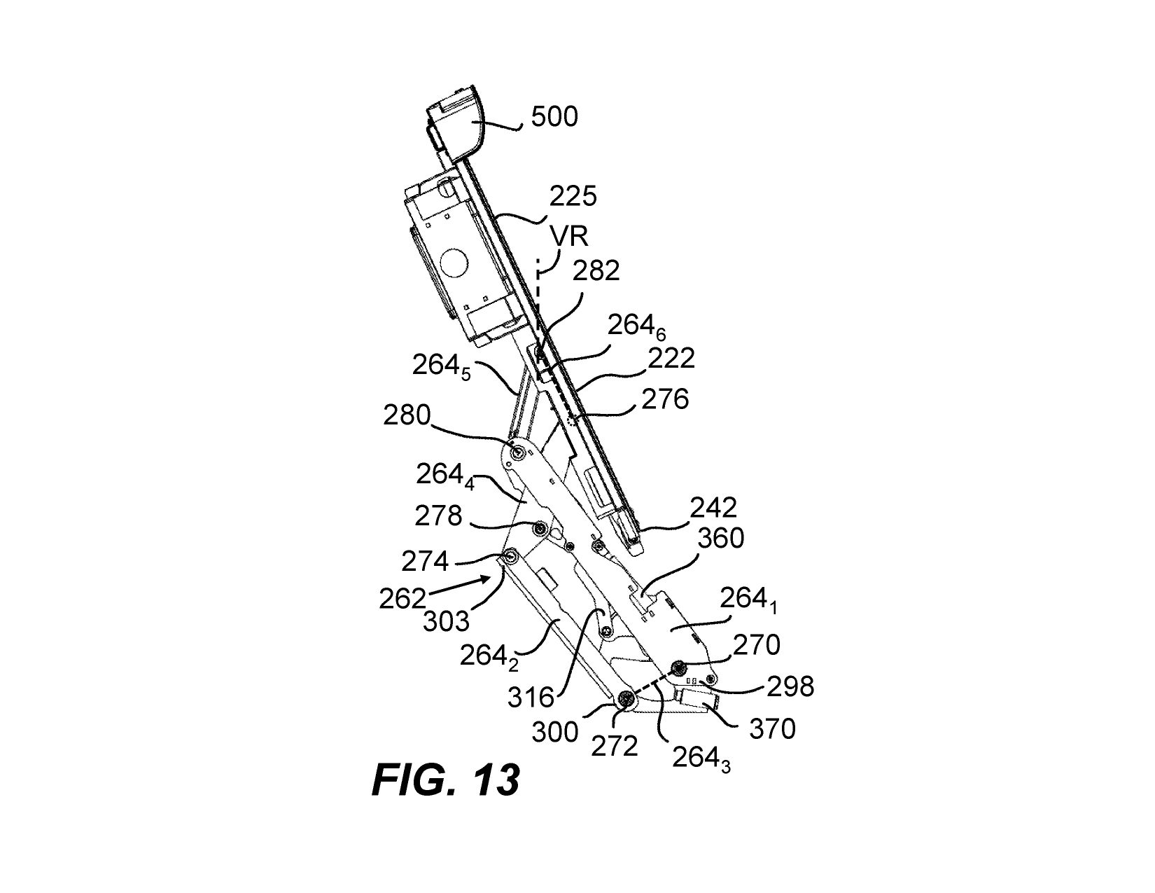

In this embodiment, the joints 270, 272 are the only connection that the linkage assembly 262 has with the upper frame 200 and therefore the articulation mechanism 260 has minimal connections with the upper frame 200. This can be beneficial for assembling the bed 100, as the upper body deck section 214 can be readily assembled apart from the remainder of the bed 100 and later mounted to the upper frame 200 via the joints 270, 272. Moreover, as will be appreciated, both joints 270, 272 are positioned relatively close to the foot end of the upper body deck section 214. For instance, throughout movement of the supporting structure 225 between the lowered position and the fully raised position, all of the joints interconnecting the upper body deck section 214 to the upper frame 200, namely the joints 270, 272, remain on a foot side (i.e., footward) of a vertical plane VR (FIGS. 5, 13) bisecting a length of the deck section panel 222. As a result, as best seen in FIG. 9, the upper frame 200 is free of any joints connecting with the articulation mechanism 260 on a head side of the vertical plane VR bisecting the length of the deck section panel 222. This results in a significant amount of free space behind the upper body deck section 214 in the raised position which can be useful for accommodating medical instruments which may be used on the patient when they are lying on the bed, such as medical imaging instruments (e.g., fluoroscopy instruments).

Referring now to FIG. 14, the top crank link 264₁has an inner side member 284 and an outer side member 286 disposed laterally outwardly of the inner side member 284. The inner and outer side members 284, 286 are planar components interconnected by the pivots of joints 270, 280, by transversal pins 288, 290, 292, and by a transversal interconnecting plate 294. The inner and outer side members 284, 286 extend from the proximal end 298 to a distal end 299 of the top crank link 264₁. The inner and outer side members 284, 286 are disposed on either side of the central link 264₄ and the outer link 264₅ (i.e., the central link 264₄ and the outer link 264₅ are disposed between the inner and outer side members 284, 286) to laterally contain and thereby limit the lateral extent of the linkage assembly 262, and also to provide more rigidity to the linkage assembly 262. In this embodiment, the top crank link 264₁ also includes an extension 296 that is connected to the inner and outer side members 284, 286 and is disposed therebetween. Notably, the extension 296 is connected to the inner and outer side members 284, 286 by the transversal pins 288, 290 that fix the extension 296 relative to the inner and outer side members 284, 286. It is contemplated that, in other embodiments, the extension 296 could be integrated as part of the inner and outer side members 284, 286.

The bottom crank link 264₂ has a U-shaped profile along a majority of its length defined between the proximal end 298 and a distal end 303 thereof. Notably, the bottom crank link 264₂ has two side walls 305 and a central bottom wall 307 extending between the side walls 305. The U-shaped profile of the bottom crank link 264₂ may be beneficial for its rigidity. In this example, the width of the bottom crank link 264₂ defined between the side walls 305 is approximately equal to the width of the top crank link 264₁ defined between the inner and outer side members 284, 286.

As shown in FIG. 13, the top and bottom crank links 264₁, 264₂ are interconnected by the frame link 264₃, illustrated in dashed lines, which is representative of the upper frame 200. The frame link 264₃ is a ground link and thus remains fixed in place relative to the upper frame 200 when the linkage assembly 262 is in motion. As such, the pivot axes defined by the joints 270, 272 remain fixed in place relative to the upper frame 200.

With reference to FIGS. 13 and 14, the central link 264₄ is pivotably connected at a proximal end 308 thereof to the bottom crank link 264₂ at a joint 274 and at an opposite distal end 310 thereof to the chassis 248 of the supporting structure 225, namely to a corresponding longitudinal member 250 at a joint 276. In this embodiment, the central link 264₄ extends footwardly and vertically upwardly from the joint 274, irrespective of the position of the upper body deck section 214. In other words, throughout the range of motion of the upper body deck section 214, the joint 276 is footward and vertically higher than the joint 274.

The central link 264₄ is also pivotably connected to the top crank link 264₁, namely to the extension 296, at a joint 278 disposed between the proximal and distal ends 298, 299 of the top crank link 264₁. As will be appreciated, the central link 264₄ and the top crank link 264₁ are ternary links as they each have three joints. The connection between the central link 264₄ and the top crank link 264₁ results in the central link 264₄ extending through the top crank link 264₁, in a side elevation view of the linkage assembly 262, irrespective of a position of the supporting structure 225. In other words, when looking at the linkage assembly 262 from the side (such as in FIGS. 5 and 13), the central link 264₄ can be seen crossing the top crank link 264₁.

In this embodiment, the central link 264₄ has an inner side member 302 and an outer side member 304 disposed laterally outwardly of the inner side member 302. The inner and outer side members 302, 304 extend from the proximal end 308 to the distal end 310 of the central link 264₄ and are fixed to each other so as to move together. The inner and outer side members 302, 304 are disposed on opposite lateral sides of the extension 296 and are pivotably connected thereto at the joint 278.

As will be appreciated, the joint 278 about which the central link 264₄ is pivotably connected to the top crank link 264₁ is offset from an axis traced to extend through the centers of the joints 274, 276 at the proximal and distal ends 308, 310 of the central link 264₄. As such, as can be gathered from FIGS. 13 and 17 to 19, a triangle can be traced through the centers of the joints 274, 276, 278, with their respective pivot axes forming the vertices of the triangle. Similarly, the joint 278 is offset from an axis traced through the centers of the joints 270, 280 at the proximal and distal ends 298, 299 of the top crank link 264₁. As such, a triangle can be traced through the centers of the joints 270, 278, 280, with their respective pivot axes forming the vertices of the triangle.

The outer link 264₅ is pivotably connected to the top crank link 264₁ at a joint 280 formed at a proximal end 312 of the outer link 264₅. The outer link 264₅ is also pivotably connected to the chassis 248, namely to the corresponding longitudinal member 250 at a joint 282 formed at a distal end 314 of the outer link 264₅. As can be seen, the joint 282 is disposed further headward from the joint 276 formed between the central link 264₄ and the chassis 248. As such, in the fully raised position, the joint 282 is disposed vertically higher than the joint 276.

Lastly, the distal ends of the central link 264₄ and the outer link 264₅ are interconnected by the supporting structure link 264₆, illustrated in dashed lines, which is representative of the supporting structure 225. The supporting structure link 264₆ is thus a coupler link.

Together, the above-described links 264₁-264₆ direct the motion of the supporting structure 225 of the upper body deck section 214. As will be appreciated, the links 264₁-264₆ could be configured differently in other embodiments. For instance, while in some embodiments, the links are described as having a particular width by having inner and outer side members (e.g., the top crank link 264₁) or by having a U-shaped profile (e.g., the bottom crank link 264₂), the links could instead be single plate members that are stacked in the lateral direction and connected to each other to form the same geometry. Other modifications will be apparent to the person skilled in the art.

With reference to FIG. 14, the articulation mechanism 260 also includes left and right actuation links 316 connected to the respective linkage assemblies 262. Notably, each actuation link 316 operatively connects the corresponding linkage assembly 262 to an actuator 350 (FIGS. 4, 5) configured to impart motion to the linkage assembly 262. The actuation link 316 extends from a proximal end 318 to a distal end 320. The actuation link 316 is generally S-shaped, having a middle portion 319 that is at an angle relative to a proximal portion 317 and a distal portion 321 extending from either side of the middle portion 319. The actuation link 316 may be shaped differently in other embodiments (e.g., could be rectilinear or curved in other embodiments). The distal end 320 of the actuation link 316 is pivotably connected to the central link 264₄at a joint 322 that is disposed, along a length of the central link 264₄, between the joint 278 (formed between the central link 264₄ and the top crank link 264₁) and the joint 276 (formed between the top crank link 264₁ and the chassis 248).

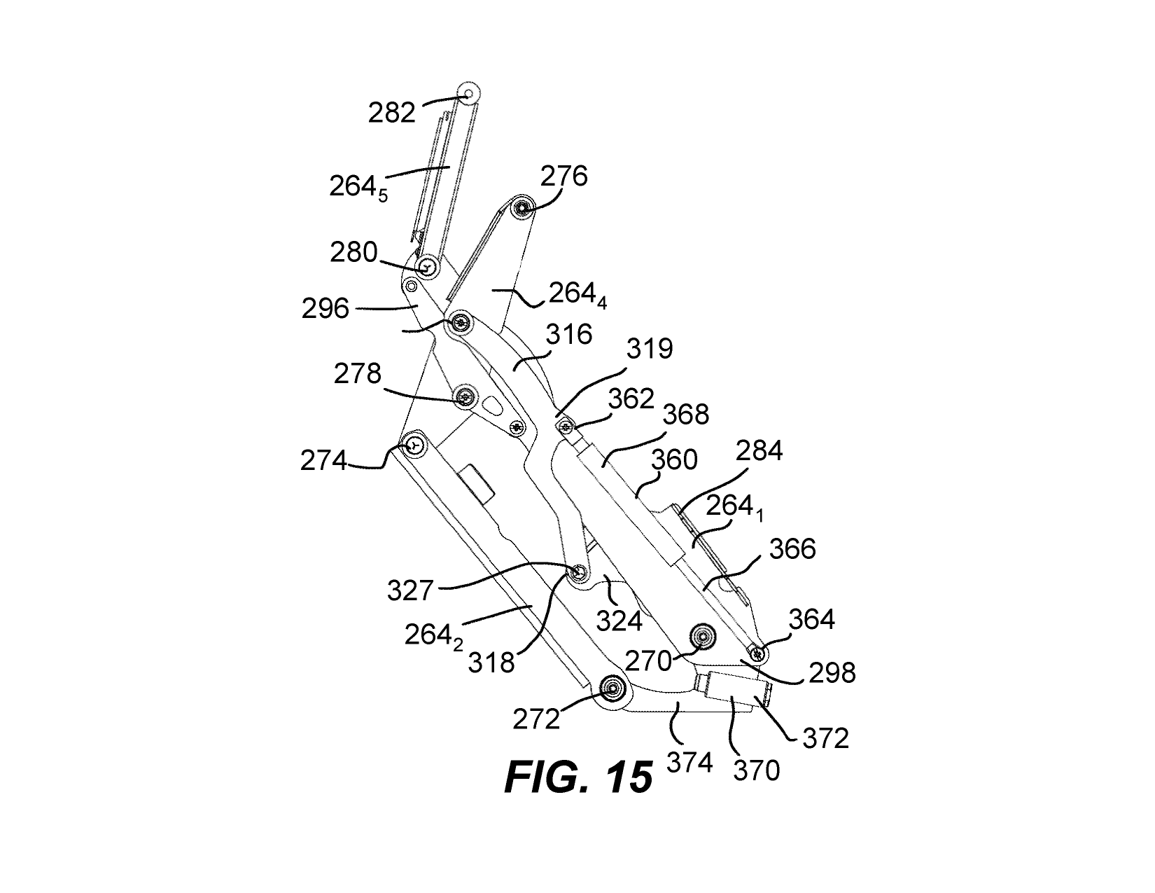

With reference to FIGS. 11 and 15, the proximal end 318 of the actuation link 316 is pivotably connected to a corresponding crank arm 324 at a joint 327. The crank arm 324 is connected (e.g., welded) to an actuation shaft 326 (FIGS. 10, 12) that extends laterally. Notably, a left crank arm 324 extends from a left end of the actuation shaft 326 and a right crank arm 324 extends from a right end of the actuation shaft 326. An actuator mount 328 is connected to the actuation shaft 326 at a location between the crank arms 324. The actuator mount 328 consists of two flanges that extend from the actuation shaft 326.

As best shown in FIGS. 4 and 5, the actuator 350 is connected between the actuator mount 328 of the articulation mechanism 260 and the upper frame 200. In particular, a moving end 352 of the actuator 350 is pivotably connected to the actuator mount 328, and an opposite fixed end 354 of the actuator 350 is pivotably connected to the transversal member 204b of the upper frame 200. The moving end 352 moves relative to the fixed end 354 as the actuator 350 extends and retracts. This causes the actuator mount 328 to force the actuation shaft 326 to pivot about a lateral pivot axis, which in turn causes the crank arms 324 to actuate the respective actuation links 316. The actuation links 316 consequently cause the central links 264₄ of the linkage assemblies 262 to move the upper body deck section 214 towards the lowered position or the fully raised position. In some embodiments, the actuator 350 may be indirectly connected to the actuator mount 328. For instance, an additional connector may be disposed between the actuator 350 and the actuator mount 328, and the additional connector could also be pivotably connected to the upper frame 200. This may reduce the load exerted by the actuator 350 to actuate the articulation mechanism 260.

In this embodiment, the actuator 350 is an electrical linear actuator having a motor 356 that is controlled by a controller (not shown) of the bed 100. The controller is responsive to inputs such as lower and raise commands sent from a user interface of the bed 100 (e.g., a touch screen or a command panel).

Returning to FIG. 14, in this embodiment, each linkage assembly 262 also includes a damper 360 for damping a motion of the upper body deck section 214 as it moves towards the lowered position. The damper 360 is connected between the actuation link 316 and the top crank link 264₁ of the linkage assembly 262. Notably, as best shown in FIG. 15 which illustrates the linkage assembly 262 in the fully raised position and with the outer side member 286 of the top crank link 264₁ removed, a fixed end 362 of the damper 360 is pivotably connected to the middle portion 319 of the actuation link 316 and a movable end 364 of the damper 360 is pivotably connected to the proximal end 298 of the top crank link 264₁. The movable end 364 is disposed at the end of a piston rod 366 that is retractable in and out of a cylinder 368 of the damper 360. In this embodiment, the movable end 364 is pivotably connected to the proximal end 298 of the top crank link 264₁ by the transversal pin 292. The piston rod 366 exhibits resistance to being retracted into the cylinder 368, but substantially no resistance to being retracted out of the cylinder 368. Thus, as will be appreciated, the damper 360 slows movement of the upper body deck section 214 towards the lowered position. This may promote a softer movement of the upper body deck section 214 toward the lowered position which can be particularly useful in the event that cardiopulmonary resuscitation (CPR) is required on a patient on the bed 100. Notably, in such an event, a CPR function of the bed 100 is activated (e.g., by pulling a CPR lever or pressing a CPR pedal of the bed 100) which causes a mechanical disconnection of the motor 356 of the actuator 350 from the movable end 352 thereof, thus causing the weight of the upper body deck section 214 and the patient to force the retraction of the actuator 350 so that the upper body deck section 214 quickly reaches the lowered position. By slowing down the descent of the upper body deck section 214, the dampers 360 prevent the upper body deck section 214 from moving to the lowered position in an overly rapid and potentially hazardous manner. As will be appreciated, the dampers 360 are not connected to the upper frame 200, instead being wholly integrated into the articulation mechanism 260 of the upper body deck section 214, contributing to the modularity of the upper body deck section 214.

The dampers 360 may be configured differently in other embodiments. For example, in some embodiments, the dampers 360 may instead be connected between the upper frame 200 and the articulation mechanism 260. In some cases, a damper may be integrated within the actuator 350 and thus the dampers 360 may be omitted.

Returning now to FIGS. 10 to 14, in this embodiment, each linkage assembly 262 also includes a biasing assembly 370 for biasing the upper body deck section 214 towards the fully raised position when the upper body deck section 214 is in the lowered position. This may be helpful to reduce a load on the actuator 350 when the actuator 350 begins raising the upper body deck section 214 in the lowered position, which is otherwise an instant at which the power demand on the actuator 350 is the highest during motion of the upper body deck section 214. In turn, this may allow the selection of a more affordable actuator 350 rather than one that is rated to satisfy a greater load requirement.

With reference to FIGS. 14-16, in this embodiment, the biasing assembly 370 includes a cylindrical sleeve 372 welded to a bracket 374, a piston 376 received within the sleeve 372 and movable axially along the sleeve 372, and a biasing element 378 that biases the piston 376 headward along the sleeve 372. A cap 380 is secured to the sleeve 372 to close off one end thereof. In this example, the cap 380 is threadedly secured to the sleeve 372. The bracket 374 is connected to the top crank link 264₁ and the upper frame 200 at the joints 270, 272.

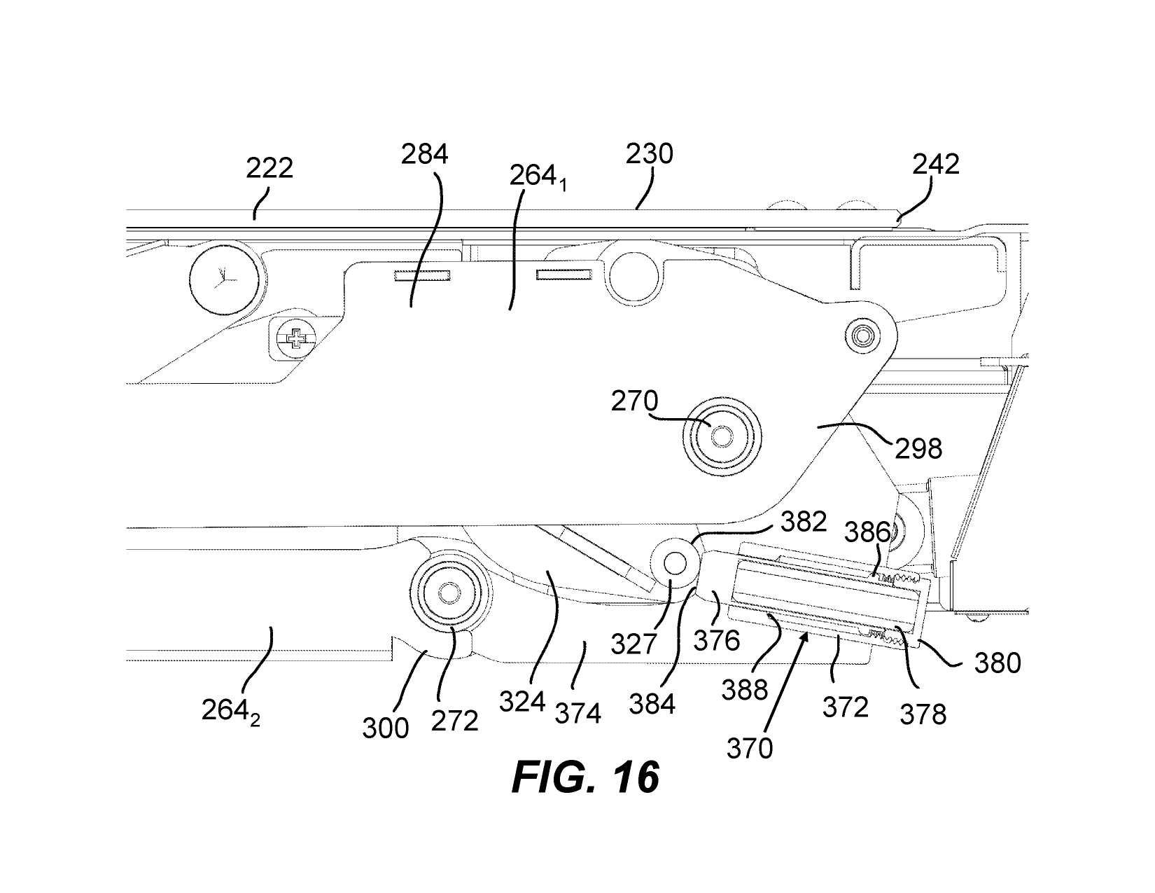

As shown in FIG. 16, in the lowered position, an end 384 of the piston 376 abuts a sleeve 382 of the joint 327 between the actuation link 316 and the crank arm 324 as the biasing element 378, which is contained within a cavity of the piston 376 and supported by the cap 380, pushes the piston 376 outward through an open end of the sleeve 372. As the upper body deck section 214 starts raising from the lowered position in response to the actuator 350 extending, the piston 376 keeps abutting the joint 327 until either the joint 327 is out of reach of the 376 or the piston 376 reaches the limit of its race along the sleeve 372. In particular, an outer annular protrusion 386 of the piston 376 contacts an inner shoulder 388 of the sleeve 372 to limit the race of the piston 376 and prevent the piston 376 from being dislodged from the sleeve 372.

In this embodiment, the biasing element 378 is a coil spring. The biasing element 378 could be a different type of biasing element in other embodiments.

The biasing assembly 370 may be configured differently in other embodiments. In yet other embodiments, the biasing assembly 370 may be omitted altogether.

While the articulating mechanism 260 has been described as having two linkage assemblies 262, it is contemplated that a single linkage assembly 262 could be provided in other embodiments. For example, a single central linkage assembly could be used instead of left and right linkage assemblies 262.

The articulating mechanism 260 as described above provides for a displacement of the supporting structure 225 that changes an angle of the supporting structure 225 but also translates it in such a manner as to provide a comfortable movement for the patient as the upper body deck section 214 is moved between the lowered position and the fully raised position. In addition, the articulating mechanism 260 may reduce patient migration (i.e., undesirable displacement of the patient along the bed) during movement of the upper body deck section 214 compared to conventional beds, thereby relieving caregivers from physical exertion that would otherwise be required to reposition the patient on the bed after moving the upper body deck section.

The trajectory of the supporting structure 225 will now be described in greater detail with reference to FIGS. 17 to 19 which illustrate a schematic representation of the upper body deck section 214 as it is moved from the lowered position to the fully raised position.

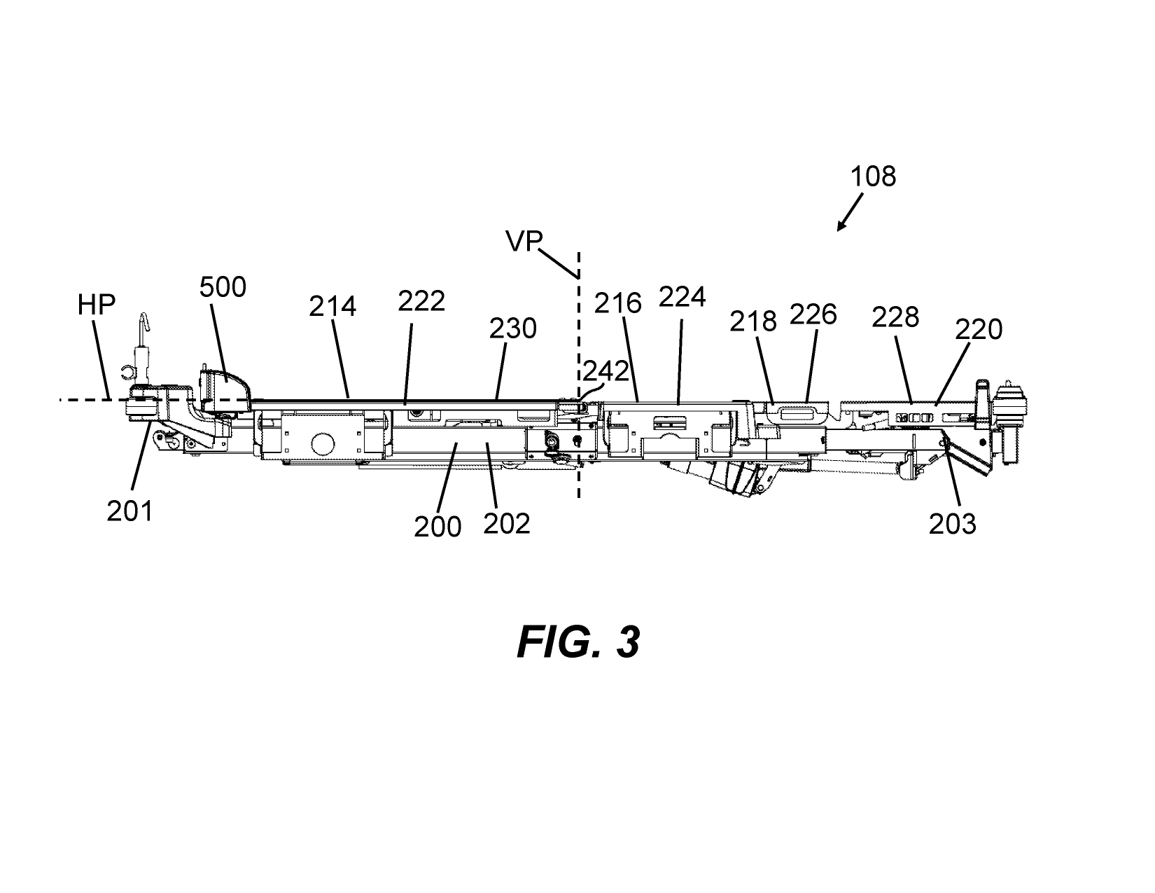

As shown in FIGS. 3 and 17, in the lowered position, the deck section panel 222 extends generally along a horizontal plane HP that extends parallel to the upper frame 200. In other words, in the lowered position, the deck section panel 222 extends horizontally, at an angle of 0° relative to the horizontal plane HP. Thus, when the upper frame 200 is set horizontally (with the height of the head end and foot end lift assemblies 118, 120 being equal), the deck section panel 222 is parallel to a floor surface on which the bed 100 is supported when the upper body deck section 214 is in the lowered position. In the lowered position, the head end 240 and the foot end 242 of the deck section panel 222 are disposed at the same height (i.e., a height of 0 mm relative to the horizontal plane HP), such that the horizontal plane HP extends through the head end 240 and foot end 242 of the deck section panel 222. As will be appreciated, since the deck section panel 222 is generally coplanar with the deck section panel 224 of the seat deck section 216 in the lowered position of the upper body deck section 214, the horizontal plane HP also extends through the seat deck section panel 224. For purposes of referencing the displacement of the deck section panel 222 longitudinally further below, a vertical plane VP (orthogonal to the horizontal plane HP) in FIGS. 3 and 17 to 19 can be seen extending through the foot end 242 of the deck section panel 222 in the lowered position, and therefore the foot end 242 is at a longitudinal distance of 0 mm from the vertical plane VP.

As the upper body deck section 214 moves towards the raised position, passing through many intermediate positions in between (an exemplary intermediate position being illustrated in FIGS. 7 and 18), the angle defined between the deck section panel 222 and the horizontal plane HP increases. For instance, in the intermediate position shown in FIGS. 7 and 18, the angle is denoted as angle αₜ that is greater than in the lowered position (e.g., 15°). As can be seen, the foot end 242 is also vertically higher and longitudinally more headward than in the lowered position.

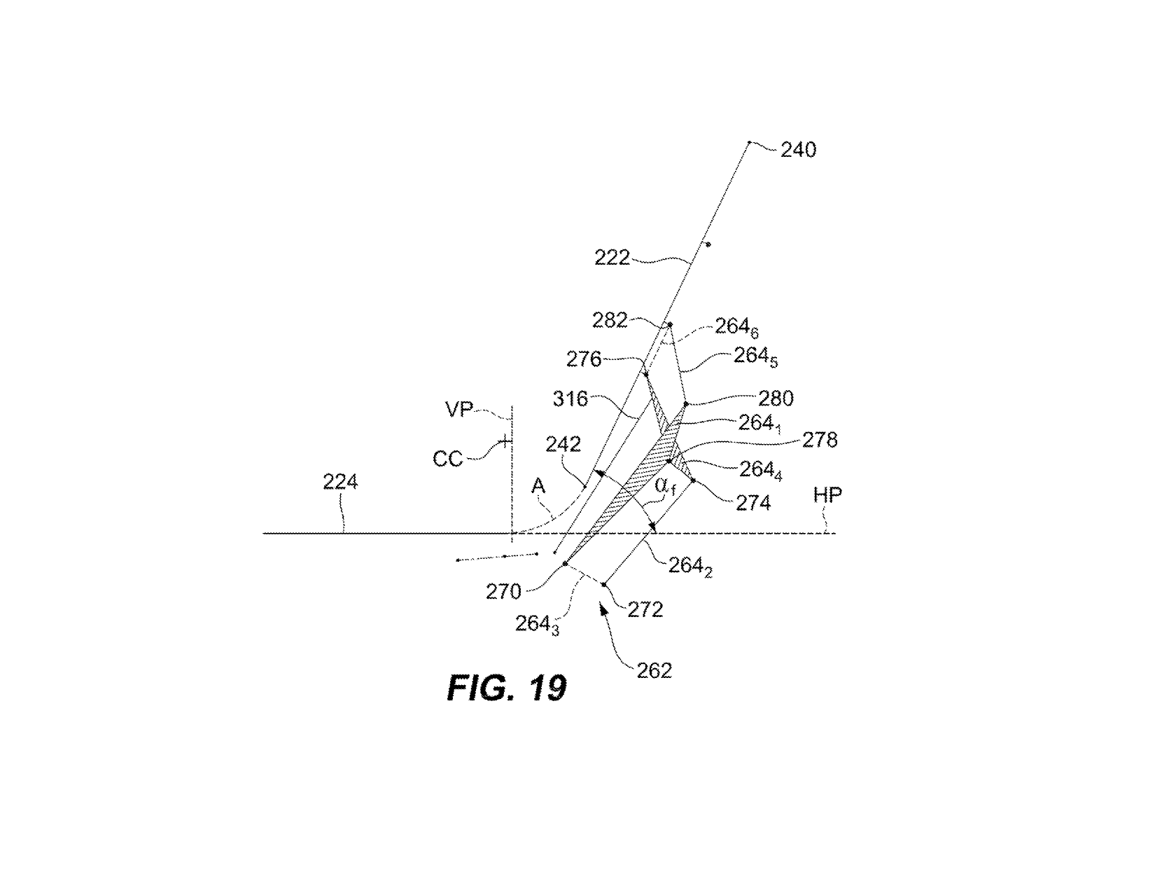

As shown in FIGS. 9 and 19, in the fully raised position, an angle α_{f} defined between the deck section panel 222 and the horizontal plane HP is approximately 65°. The angle α_{f} at the fully raised position may be different in other embodiments (e.g., any angle approximately equal to or greater than 60°). The foot end 242 of the deck section panel 222 is disposed at a height H_{R} from the horizontal plane HP, such that the foot end 242 is vertically higher in the fully raised position than in the lowered position. In this embodiment, the height H_{R} is greater than 150 mm. In particular, the height H_{R} may be approximately 182 mm. In the longitudinal direction, in the fully raised position, the foot end 242 of the deck section panel 222 is at a distance D_{R} headward (i.e., longitudinally in the direction of the head end 102 of the bed 100) from the vertical plane VP. In this embodiment, the distance D_{R} is greater than 130 mm. In particular, the distance D_{R} may be approximately 160 mm. The height H_{R} and the distance D_{R} may be different in other embodiments.

As will be appreciated from the above, the configuration of the articulation mechanism 260 and its linkage assemblies 262 results in the displacement of the supporting structure 225 being continuously positive as it is moved from the lowered position to the fully raised position. In this context, a positive movement of the supporting structure 225 can be defined as a combination of (i) an increase in the angle α defined between the deck section panel 222 and the horizontal plane HP, (ii) a headward translation of the foot end 242 of the deck section panel 222, and (iii) an upward vertical translation of the foot end 242 of the deck section panel 222. This positive movement has been observed to be beneficial for the patient’s comfort as the upper body deck section 214 is raised. Notably, it has been observed by the inventors that a certain increase in a patient’s length can be measured when the torso rotates about the hips relative to the patient’s lower body. For instance, the length of patient’s body as measured from the feet to the head increases when the patient transitions from a lying flat position (i.e., in the lowered position of the upper body deck section 214) to a seated position whereby the patient’s upper body is raised (i.e., in the raised position of the upper body deck section 214). Thus, by providing the continuous positive movement of the upper body deck section 214 described above, the increase in the patient’s length can be at least partly compensated to minimize undesired patient migration along the bed 100.

With continued reference to FIGS. 17 to 19, the trajectory of the deck section panel 222 between the lowered position and the fully raised position can be defined relative to an arc A traced in a side elevation view of the upper body deck section 214. In this example, the arc A is the section of a circle centered about a center axis CC and having a radius R. Vertically, the center axis CC is disposed higher than the horizontal plane HP, and longitudinally near the foot end 242 of the deck section panel 222 in the lowered position, thus near the vertical plane VP. In other embodiments, the arc A could be the section of an ellipse centered about the center axis CC. As can be seen in FIGS. 17 to 19, the deck section panel 222 remains generally tangential to the arc A as the upper body deck section 214 moves between the lowered position and the fully raised position. By remaining generally tangential to the arc A, the deck section panel 222 undergoes a continuous positive movement. Notably, in this example, the vertically lowest point of the arc A corresponds to the foot end 242 of the deck section panel 222 in the lowered position. As such, the foot end 242 of the deck section panel 222 travels generally along the arc A as the upper body deck section 214 is moved between the lowered and fully raised positions. Therefore, as the upper body deck section 214 moves from the lowered position to the fully raised position, or vice-versa, the foot end 242 of the deck section panel 222 does not descend vertically lower than the horizontal plane HP. Such a trajectory can contribute to the comfort of the patient on the bed 100.

The linkage assembly 262 is relatively compact in the lowered position of the upper body deck section 214 as can be appreciated in FIG. 17. For instance, in the lowered position, the top and bottom crank links 264₁, 264₂ extend generally horizontally and parallel to each other. Furthermore, in the lowered position, the central link 264₄ forms an acute angle (i.e., an angle less than 45°) with the bottom crank link 264₂. Similarly, the outer link 264₅ forms an acute angle with the top crank link 264₄. As a result, a vertical distance between the joints 272, 274 and the joints 276, 282, which defines the height of the linkage assembly 262, is at its smallest in the lowered position. In addition, in the lowered position, the joint 280 is the headwardmost joint of the linkage assembly 262 (i.e., the joint that is positioned closest to the head end of the upper body deck section 214).

As can be seen in FIGS. 18 and 19, the linkage assembly 262 expands as it moves towards the raised position. In particular, when the upper body deck section 214 moves towards the raised position, the top and bottom crank links 264₁, 264₂ pivot upwardly about the joints 270, 272, thereby extending footwardly and vertically upward. As such, the respective heights of the joints 274, 280 at the distal ends of the top and bottom crank links 264₁, 264₂ increases, reaching their maximum values at the raised position (FIG. 19). Moreover, simultaneously, the angle defined between the central link 264₄ and the bottom crank link 264₂ increases as the upper body deck section 214 moves towards the raised position, reaching its maximum value in the raised position, whereby the angle is an obtuse angle. Similarly, the angle defined between the outer link 264₅ and the top crank link 264₁ increases as the upper body deck section 214 moves towards the raised position, reaching its maximum value in the raised position, whereby the angle is an obtuse angle.

As will be appreciated, the linkage assemblies 262 achieve a continuously positive movement while being free of slotted guides that guide the movement of one or more articulating members.

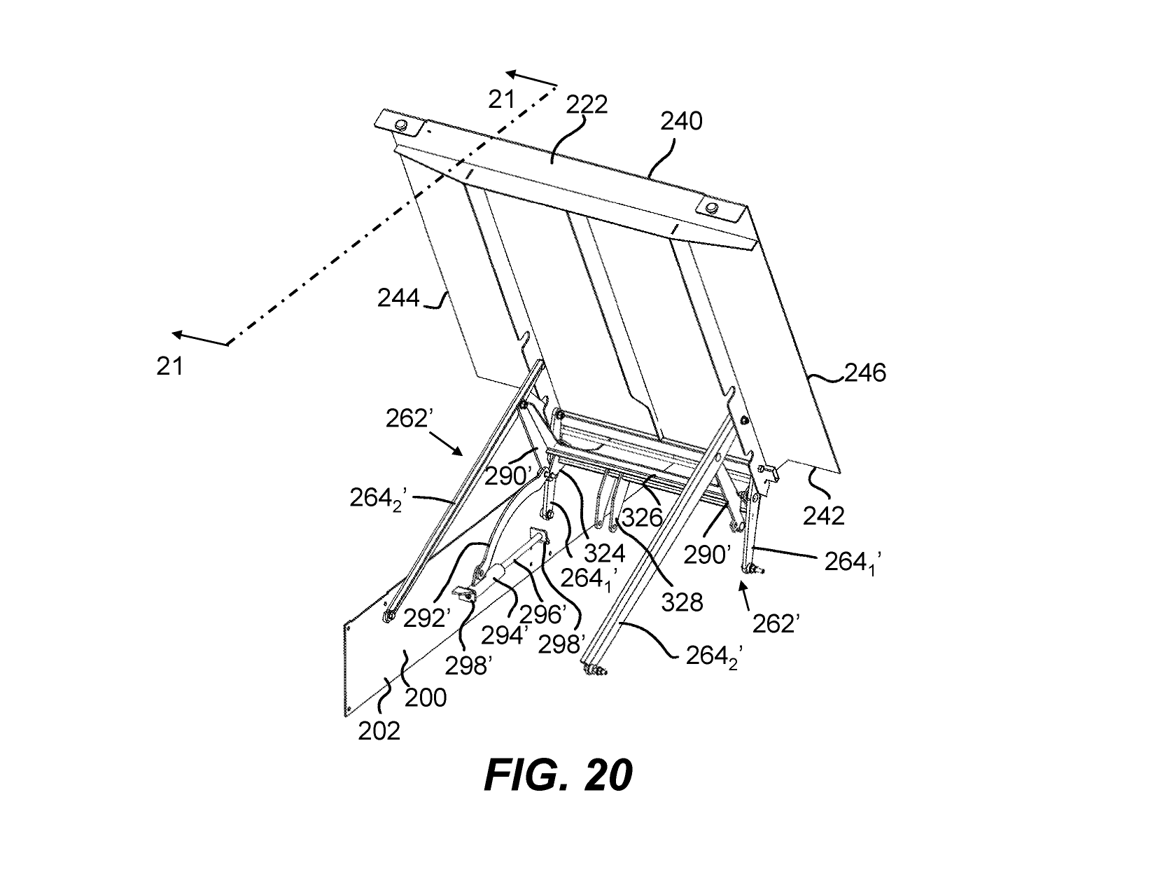

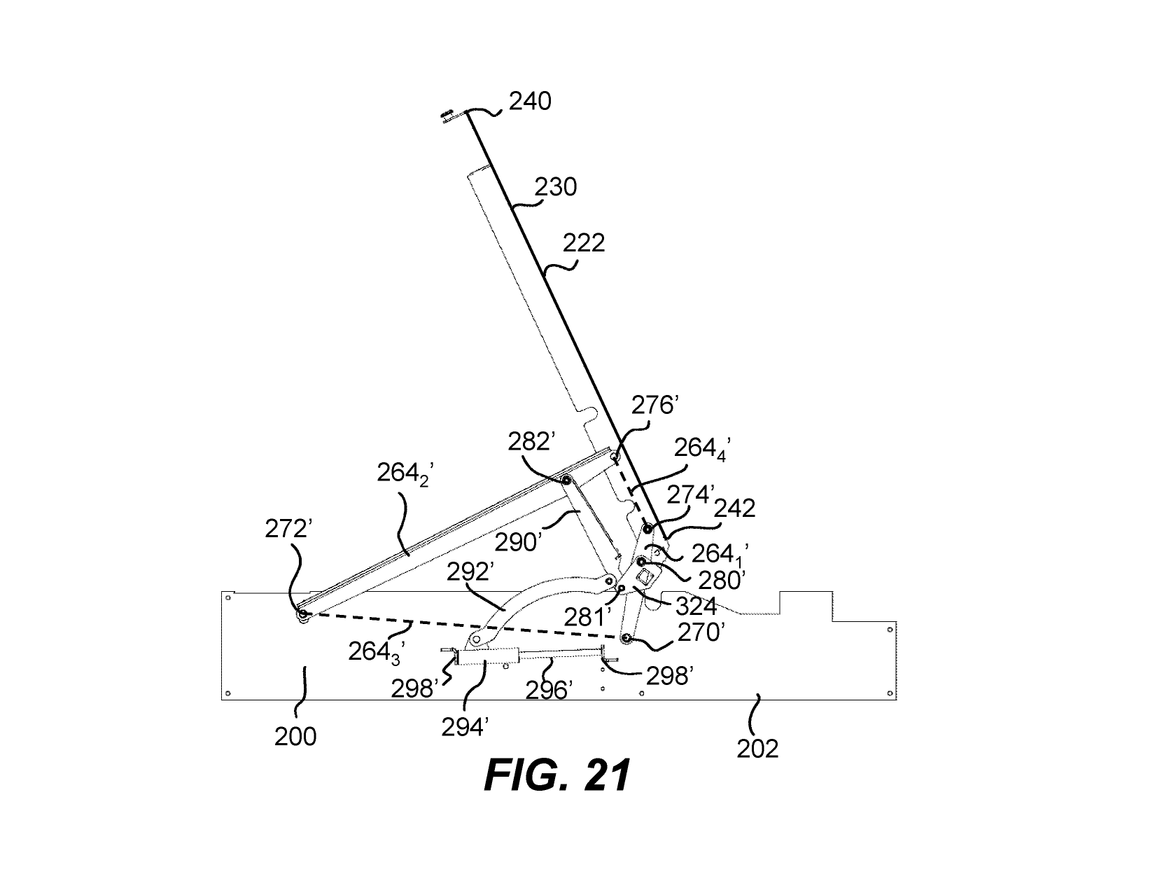

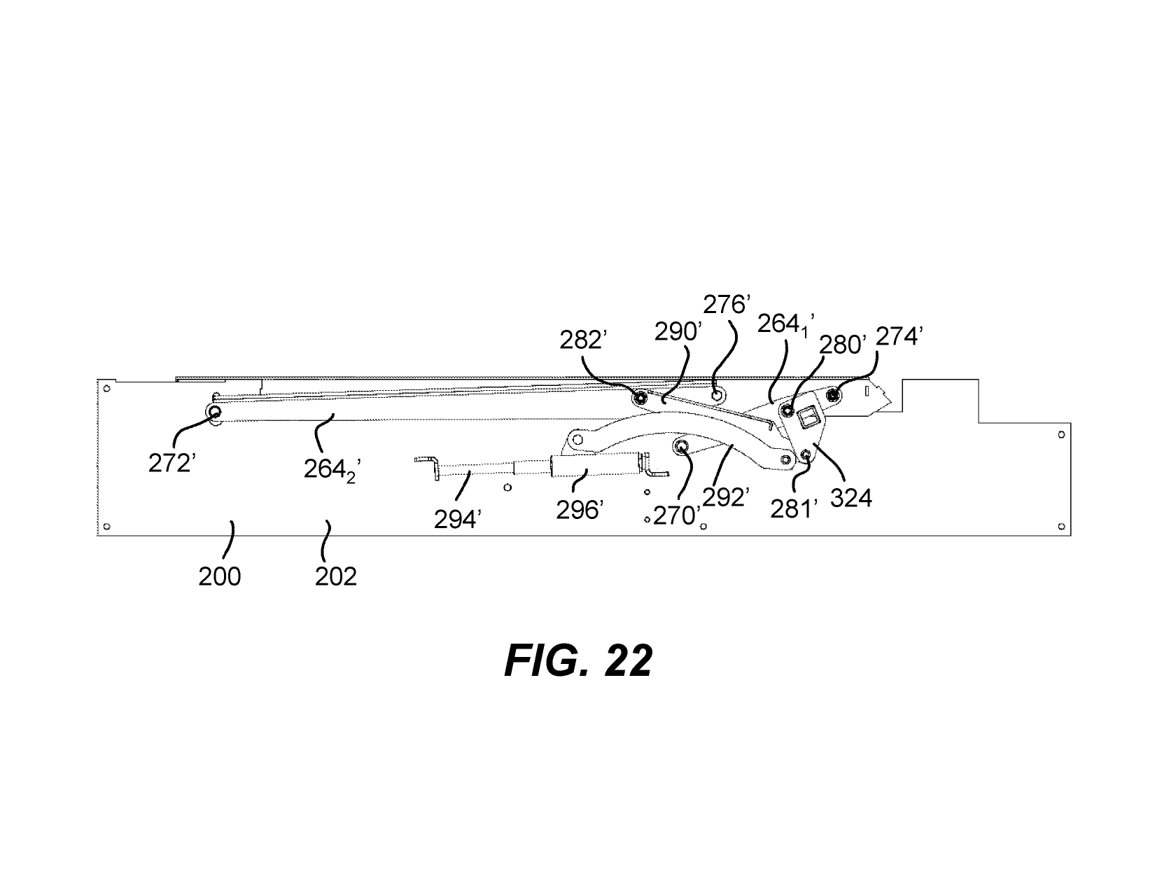

An alternative embodiment of the articulation mechanism 260 is illustrated in FIGS. 20 to 22 in which the articulation mechanism 260 includes left and right linkage assemblies 262’ that operatively connect the supporting structure 225 to the upper frame 200. Certain components of the right linkage assembly 262’ and of a right side of the upper frame 200 are not shown to prevent obscuring other components. The left and right linkage assemblies 262’ are mirror images of each other and therefore only the left linkage assembly 262’ will be described herein. It is to be understood that the same description applies to the right linkage assembly 262’.

The linkage assembly 262’ includes a plurality of links that are pivotably connected to each other and collaborate to guide movement of the supporting structure 225 between the lowered position and the fully raised position. In this embodiment, the linkage assembly 262’ includes a four-bar linkage that includes four links and four joints (defining pivot axes extending laterally) governing the movement of the supporting structure 225. The four links of the four-bar linkage include a front link 264₁’, a rear link 264₂’, a frame link 264₃’ and a supporting structure link 264₄’.

The front link 264₁’ is pivotably connected at one end thereof to the upper frame 200 at a joint 270’. An opposite end of the front link 264₁’ is pivotably connected to the chassis 248, namely to the corresponding longitudinal member 250 at a joint 274’. The rear link 264₂’ is pivotably connected at one end thereof to the upper frame 200 at a joint 272’. The joint 272’ is disposed headward of the joint 270’. In particular, the joint 272’ is disposed closer to the head end 240 of the deck section panel 222 in the lowered position. An opposite end of the rear link 264₂’ is pivotably connected to the chassis 248, namely to the corresponding longitudinal member 250 at a joint 276’.

The front and rear links 264₁’, 264₂’ are interconnected by the frame link 264₃’, illustrated in dashed lines, which is representative of the upper frame 200. Notably, the frame link 264₃’ extends between the joints 270’, 272’. The frame link 264₃’ is a ground link and thus remains fixed in place relative to the upper frame 200. The front and rear links 264₁’, 264₂’are also interconnected by the supporting structure link 264₄’, illustrated in dashed lines, which is representative of the chassis 248. In particular, the supporting structure link 264₄’ extends between the joints 274’, 276’. The supporting structure link 264₄’ is thus a coupler link.

The crank arm 324 is pivotably connected to the front link 264₁’ at a joint 280’ to cause movement of the linkage assembly 262’ when the actuator 350 extends or retracts. In this embodiment, an interconnector arm 290’ is also pivotably connected to the crank arm 324 and to the rear link 264₂’ to facilitate the displacement of the rear link 264₂’. Notably, a proximal end of the interconnector arm 290’ is pivotably connected to the crank arm 324 at a joint 281’ offset from the joint 280’, and a distal end of the interconnector arm 290’ is pivotably connected to the rear link 264₂’ at a joint 282’ disposed between the joints 272’, 276’. The interconnector arm 290’ could be omitted in other embodiments.

Furthermore, in this embodiment, a proximal end of a slider arm 292’ is pivotably connected to the interconnector arm 290’ at a joint disposed between the joints 281’, 282’. Another end of the slider arm 292’ is pivotably connected to a slider 294’ that is slidable along a guide 296’. The guide 296’ is fixed to the corresponding longitudinal rail 202 of the upper frame 200. A biasing assembly includes an internal spring (not shown) mounted about the guide 296’ within the slider 294’. Two stoppers 298’ are provided at opposite ends of the guide 296’ to provide an abutment for compressing the spring when the upper body deck section 214 attains the lowered and raised positions. Notably, when the slider 294’ approaches one of the stoppers 298’, a bearing (not shown) abuts the stopper 298’ and causes a compression of the internal spring, thereby slowing the displacement of the slider 294’. This may reduce a load on the actuator 350 when the upper body deck section 214 begins moving away from the lowered position.

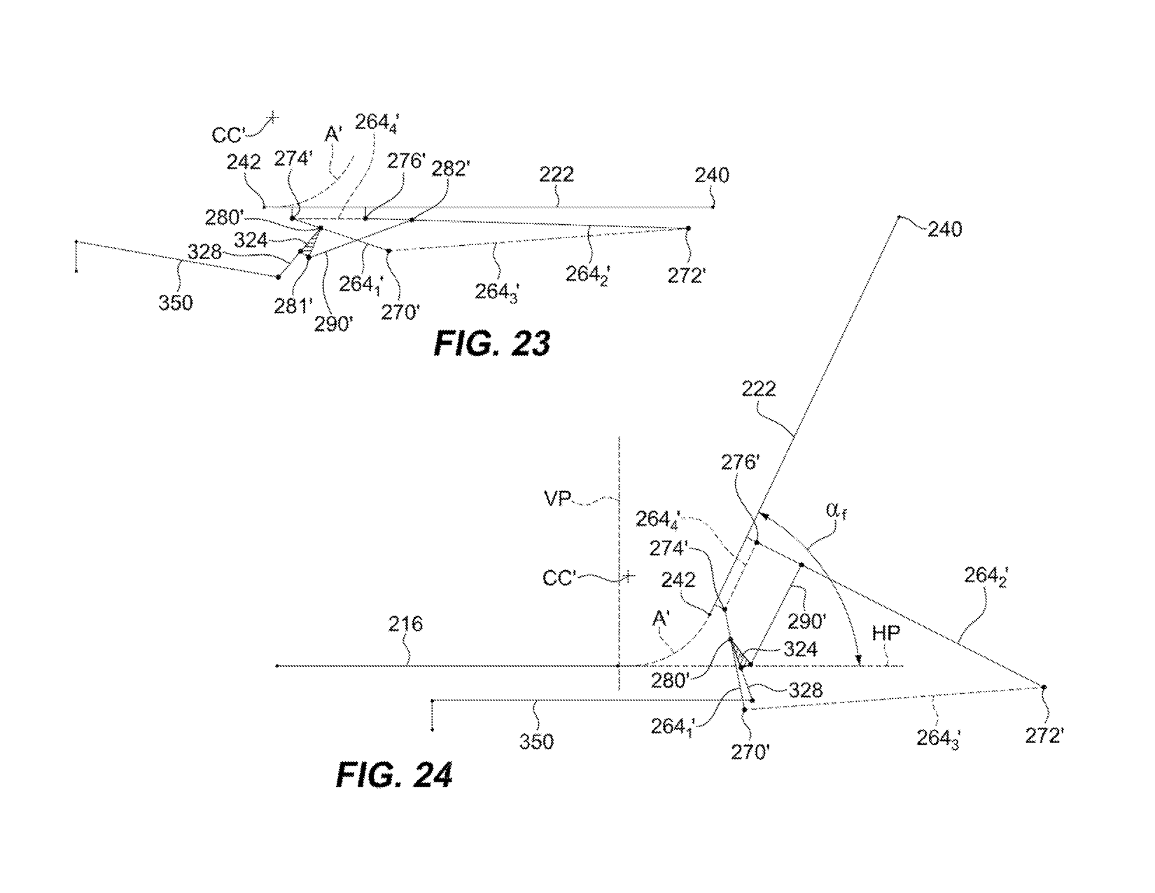

With reference to FIGS. 23 and 24, the movement provided to the deck section panel 222 by the linkage assemblies 262’ is also continuously positive as the upper body deck section 214 moves from the lowered position to the fully raised position. In particular, the deck section panel 222 remains generally tangential to an arc A’ of a circle that is centered about a center axis CC’ as the upper body deck section 214 moves from the lowered position to the fully raised position.

While the deck section panel 222 undergoing a continuous positive movement and remaining generally tangential to arcs A, A’ has been described above as taking place between the full range of motion of the upper body deck section 214 (i.e., between the flat lowered position and the fully raised position), it is contemplated that the deck section panel 222 could alternatively undergo this movement along a majority of its range of motion and not necessarily its entirety. For instance, the linkage assemblies 262, 262’ could be configured such that the deck section panel 222 instead undergoes this movement starting at any value of angle α less than or equal to 10° up to the fully raised position, or from the flat lowered position up to a value of angle α that is close to the fully raised position.

The motion performed by the deck section panel 222 as provided by the articulating mechanism 260 may also be beneficial to the design of the siderails 126 since the head siderails 126 move together with the upper body deck section 214. In particular, the motion that the head siderails 126 undergo as the upper body deck section 214 moves between the lowered and raised positions may favor a shape of the head siderails 126 that has a longer upper edge so that there is a smaller gap between the upper edges of the head siderails 126 and the upper edges of the foot siderails 126 compared to conventional beds. This can be beneficial to reduce the risk of patient entrapment between the head and foot siderails 126. In addition, a spacing between the head and foot siderails 126 may be constant throughout motion of the upper body deck section 214 which can also be beneficial to reduce entrapment risk between the head and foot siderails 126.

Returning now to FIGS. 2, 7 and 8, as the upper body deck section 214 is moved towards the fully raised position, the deck section panel 222 moves away from the seat deck section panel 224 as the seat deck section 216 remains fixed in place. This can result in a gap between the deck section panels 222, 224 that increases in size as the upper body deck section 214 moves towards the fully raised position. A gap filling panel 450 is provided to avoid such a gap which may otherwise result in a mattress overlying the deck 210 sinking into the gap which may be uncomfortable for the patient. To that end, the gap filling panel 450 extends from the seat deck section 216 and engages the upper body deck section 214. The gap filling panel 450 may be made of an elastic material such as a plastic, or even a flexible metal (e.g., aluminum).

In this embodiment, the gap filling panel 450 is integral with the seat deck section panel 224. That is, the gap filling panel 450 and the seat deck section panel 224 are a single component made of a continuous material. It is contemplated that the gap filling panel 450 could be made separately from the seat deck section panel 224 in other embodiments and be fixed (e.g., fastened) thereto.

The gap filling panel 450 is engaged by the upper body deck section 214 such that the gap filling panel 450 is elastically deformed as the upper body deck section 214 is raised, as shown in FIGS. 7 and 8. In particular, the gap filling panel 450 extends underneath the upper body deck section panel 222 and is in contact with the bottom face 235 thereof. The gap filling panel 450 is thus disposed between the deck section panel 222 and the chassis 248 to which the deck section panel 222 is fixed. In this example, the hinges 241 (FIG. 6) collaborate with the deck section panel 222 to retain part of the gap filling panel 450. This may improve the hold that the upper body deck section 214 has on the gap filling panel 450 to prevent accidental disengagement of the gap filling panel 450 by the upper body deck section 214. The gap filling panel 450 is slidable relative to the deck section panel 222 and the chassis 248 such that, as the upper body deck section 214 is raised, a greater portion of the gap filling panel 450 is uncovered since the spacing between the upper body deck section panel 222 and the seat deck section panel 224 becomes greater.

The gap filling panel 450 may be configured differently in other embodiments. In yet other embodiments, the gap filling panel 450 may be omitted altogether.

Returning now to FIG. 2, in this embodiment, the bed 100 has left and right mattress retainers 500 attached to corners of the upper body deck section 214 at the head end thereof. The mattress retainers 500 are mirror images of each other and therefore only the left mattress retainer 500 will be described in detail herein. It is to be understood that the same description applies to the right mattress retainer 500.

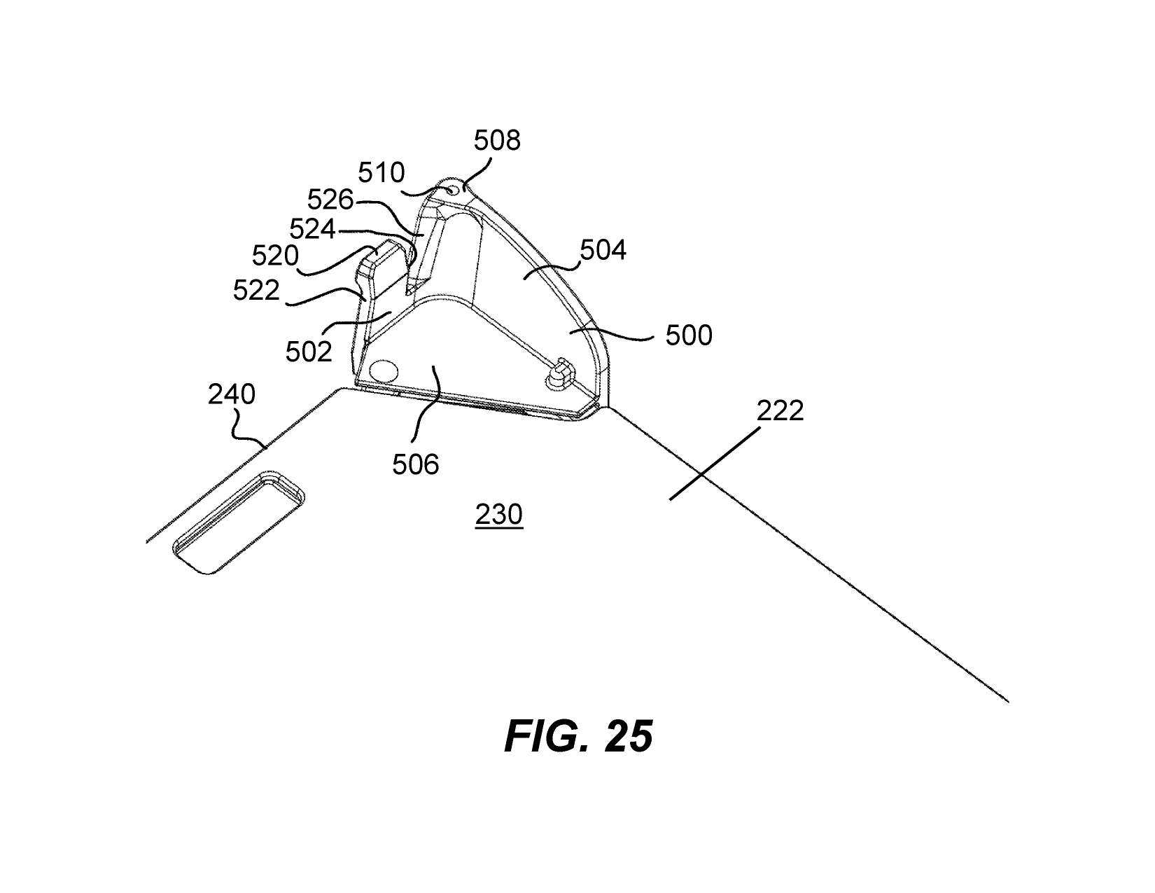

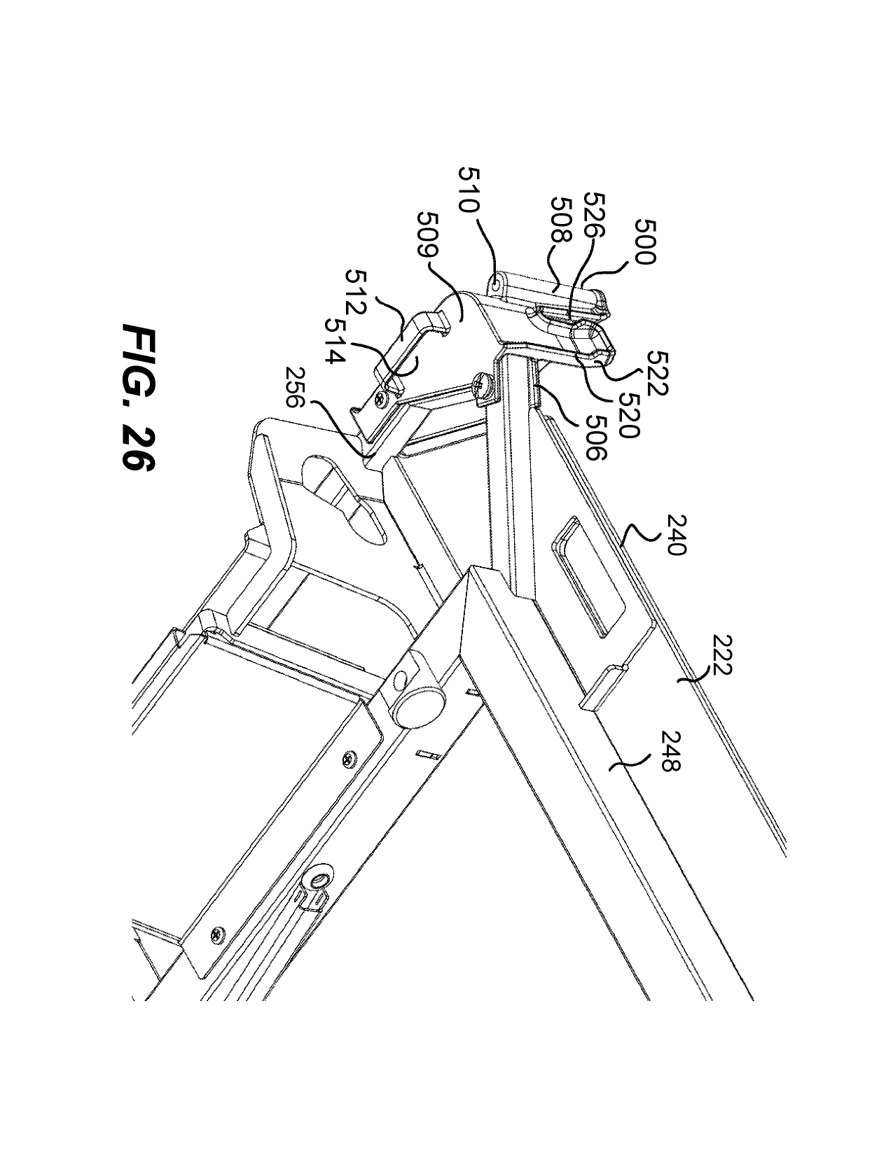

With reference to FIG. 25, the mattress retainer 500 has a rear wall 502 and a side wall 504 that are generally perpendicular to the top face 230 of the upper body deck section panel 222. The rear wall 502 extends generally laterally while the side wall 504 extends generally longitudinally. In this embodiment, the mattress retainer 500 also has a first bottom wall 506 that extends generally parallel to the top face 230 and is flush therewith. The rear wall 502 and the side wall 504 limit the lateral and longitudinal displacement of the mattress on the deck 210 respectively. As shown in FIG. 26, the mattress retainer 500 also has a second bottom wall 509 that is parallel to the bottom wall 506 and is spaced therefrom.

The mattress retainer 500 is fixed to the chassis 248 of the upper body deck section 214. In particular, as best shown in FIG. 26, the mattress retainer 500 is slid onto the chassis 248 so that part of the chassis 248 is disposed between the first and second bottom walls 506, 509. Fasteners are inserted into openings defined by the bottom walls 506, 509 to secure the mattress retainer 500 to the chassis 248.

In this embodiment, a line manager support 508 is disposed at a corner formed between the rear wall 502 and the side wall 504. The line manager support 508 is configured to support a line manager device used for keeping lines (e.g., intravenous (IV) lines, suction lines, etc.) together or separated from each other. In particular, in this example, a fastener (not shown) is inserted into opening 510 of line manager support 508 from an underside of the mattress retainer 500 and is threadedly engaged with a shaft of the line manager device.

As shown in FIG. 26, the mattress retainer 500 also has an anchor 512 extending from a lower surface of the second bottom wall 509. The anchor 512 is configured for attaching a bed sheet thereto by passing part of the bed sheet through the opening 514 and forming a knot around the anchor 512. In this embodiment, the anchor 512 has a loop-like shape and defines an opening 514 together with the second bottom wall 509. The anchor 512 could be omitted in other embodiments.

The mattress retainer 500 has a projecting coupling 520 for retaining the mattress and pulling it upward when the upper body deck section 214 is raised. The projecting coupling 520 extends generally perpendicularly from the bottom wall 506 defines in part the rear wall 502. The projecting coupling 520 has a first side edge 522 and an opposite second side edge 524 defining a width of the projecting coupling 520 therebetween. The first side edge 522 defines an end of the rear wall 502. The second side edge 524 and the line manager support 508 define a recess 526 therebetween.

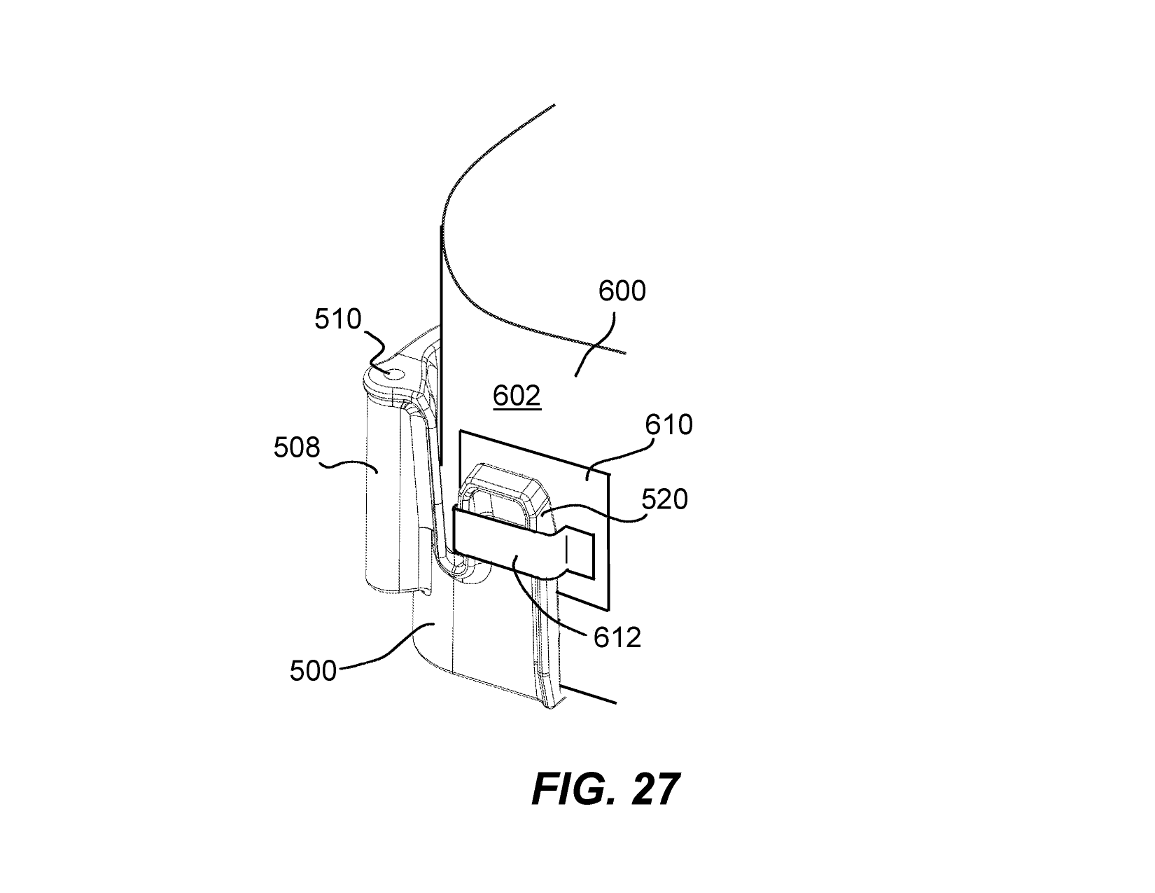

FIG. 27 illustrates the mattress retainer 500 engaged with a mattress 600 via the projecting coupling 520. As can be seen, a coupling attachment 610 is connected (e.g., welded) to a head end 602 of the mattress 600, namely to a cover of the mattress 600. The coupling attachment 610 may be made of a rigid material (e.g., a plastic material). In other embodiments, the coupling attachment 610 could be made of a soft pliable material. The coupling attachment 610 has a loop 612 that defines an opening for receiving the projecting coupling 520. To couple the mattress 600 to the mattress retainer 500, the head end 602 of the mattress 600 is set onto the deck 210 of the bed 100 and the projecting coupling 520 is inserted through the opening defined by the loop 612 so that the loop 612 surrounds the projecting coupling 520, namely around a rear face thereof and on the side edges 522, 524. In this manner, when the upper body deck section 214 is raised, the projecting coupling 520 pulls on the loop 612 and thus on the head end 602 of the mattress 600.

As will be appreciated, the mattress retainers 500 and the gap filling panel 450 may, together or individually, help keep the mattress properly positioned on the deck 210 as the upper body deck section 214 is raised toward the fully raised position.

The mattress retainer 500 may also contribute to closing off a gap between the headboard 122 and the siderails 126. Notably, the presence of the mattress retainer 500 can stop objects from passing through the gap defined between the headboard 122 and the siderails 126.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. An upper body deck section for a patient support apparatus, comprising:
a supporting structure including a deck section panel for supporting a support surface thereon, the deck section panel having a head end and a foot end opposite the head end; and
an articulation mechanism operatively connected to the supporting structure and configured to be connected to a frame of the patient support apparatus, the articulation mechanism including at least one linkage assembly including a plurality of links pivotably connected to each other and collaborating to guide movement of the supporting structure between a lowered position and a raised position, at least a majority of a range of motion of the supporting structure being spanned between the lowered position and the raised position,
in the lowered position, the deck section panel extending at a first angle relative to a horizontal plane and the foot end of the deck section panel being disposed at a first height,
in the raised position, the deck section panel being disposed at a second angle relative to the horizontal plane and the foot end of the deck section panel being disposed at a second height, the second angle being greater than the first angle, the second height being greater than the first height,
the foot end of the deck section panel being positioned further headward in the raised position than in the lowered position,
the at least one linkage assembly being configured such that, as the supporting structure is moved from the lowered position to the raised position, the foot end of the deck section panel does not move vertically lower than the first height.

2. The upper body deck section of claim 1, wherein the at least one linkage assembly is configured to guide the supporting structure such that the deck section panel remains generally tangential to an arc as the deck section panel is moved between the lowered position and the raised position.

3. The upper body deck section of claim 2, wherein the arc is a section of a circle or ellipse centered about an axis extending laterally and vertically higher than the first height.

4. The upper body deck section of claim 1, wherein the first angle is at most 10°.

5. The upper body deck section of claim 1, wherein the supporting structure comprises a chassis connected to the deck section panel, the chassis including left and right longitudinal members extending generally parallel to each other, the at least one linkage assembly being operatively connected to the chassis, the deck section panel being longitudinally fixed relative to the left and right longitudinal members.

6. The upper body deck section of claim 1, wherein each of the at least one linkage assembly is a six-bar linkage.

7. The upper body deck section of claim 1, wherein:
the plurality of links comprises:
a first link configured to be pivotably connected to the frame of the patient support apparatus at a first joint;
a second link configured to be pivotably connected to the frame of the patient support apparatus at a second joint;
a third link pivotably connected to the first link and to the supporting structure; and
a fourth link pivotably connected to the second link and to the supporting structure,
throughout movement of the supporting structure between the lowered position and the raised position, the first joint and the second joint are disposed on a foot side of a vertical plane bisecting a length of the deck section panel.

8. The upper body deck section of claim 7, wherein all connections between the at least one linkage assembly and the frame remain on the foot side of the vertical plane throughout movement of the supporting structure between the lowered and raised positions.

9. The upper body deck section of claim 7, wherein:
the third link is pivotably connected to the first link at a third joint;
the fourth link is pivotably connected to the second link at a fourth joint;
in the lowered position, a longitudinal distance between the third joint and the foot end of the deck section panel is less than a longitudinal distance between the fourth joint and the foot end of the deck section panel; and
in the raised position, the longitudinal distance between the third joint and the foot end of the deck section panel is greater than the longitudinal distance between the fourth joint and the foot end of the deck section panel.

10. The upper body deck section of claim 7, wherein, in a side elevation view of the at least one linkage assembly, the third link extends through the second link irrespective of a position of the supporting structure.

11. The upper body deck section of claim 10, wherein the third link is pivotably connected to the second link.

12. The upper body deck section of claim 1, further comprising at least one biasing assembly configured to bias the supporting structure away from the lowered position when the supporting structure is in the lowered position.

13. The upper body deck section of claim 12, wherein the biasing assembly comprises:
a sleeve;
a piston received within the sleeve and movable axially along the sleeve; and
a biasing element forcing the piston outward from the sleeve so that the piston abuts a part of the at least one linkage assembly in the lowered position of the supporting structure to bias the supporting structure toward the raised position.

14. The upper body deck section of claim 1, wherein the raised position corresponds to a fully raised position of the supporting structure.

15. The upper body deck section of claim 1, further comprising at least one retainer for limiting movement of the support surface supported by the upper body deck section,
the at least one retainer being connected to the supporting structure and projecting upwardly from the deck section panel generally perpendicularly thereto,
the at least one retainer being configured to be inserted into a slot of the support surface in order to retain the support surface relative to the deck section panel as the supporting structure moves between the lowered and raised positions.

16. A patient support apparatus comprising:
a base;
a frame movable relative to the base;
an elevation system operatively connecting the frame to the base to move the frame relative to the base; and
a deck configured to support a support surface thereon, the deck being connected to the frame, the deck including a plurality of deck sections including the upper body deck section of claim 1.

17. The patient support apparatus of claim 16, wherein the deck further comprises:
a seat deck section adjacent to the upper body deck section, the seat deck section having a seat deck section panel for supporting the support surface; and
a gap filling panel fixed to the seat deck section and engaged with the supporting structure of the upper body deck section, the gap filling panel extending between the seat deck section and the upper body deck section to fill a gap between a upper panel of the upper body deck section and the seat deck section panel, the gap filling panel elastically deforming in response to the supporting structure being moved to the raised position,
the gap filling panel being retained between the upper panel of the upper body deck section panel and a chassis of the upper body deck section.

18. The patient support apparatus of claim 17, further comprising at least one retainer for limiting movement of the support surface supported by the upper body deck section,
the at least one retainer being connected to the supporting structure and projecting upwardly from the deck section panel generally perpendicularly thereto,
the at least one retainer being configured to be inserted into a slot of the support surface in order to retain the support surface relative to the deck section panel as the supporting structure moves between the lowered and raised positions,
the at least one retainer collaborating with the gap filling panel to help the support surface follow the movement of the upper body deck section.

19. An upper body deck section for a patient support apparatus, comprising:
a supporting structure including a deck section panel for supporting a support surface thereon, the deck section panel having a head end and a foot end opposite the head end; and
an articulation mechanism operatively connected to the supporting structure and configured to be connected to a frame of the patient support apparatus, the articulation mechanism including at least one linkage assembly including a plurality of links pivotably connected to each other and collaborating to guide movement of the supporting structure between a lowered position and a raised position, at least a majority of a range of motion of the supporting structure being spanned between the lowered position and the raised position,
the at least one linkage assembly being configured such that the deck section panel remains generally tangential to an arc as the deck section panel is moved between the lowered and raised positions.

20. The upper body deck section of claim 19, wherein the arc is a section of one a circle and ellipse centered about an axis extending laterally and above a height of the deck section panel in the lowered position.
